(19) United States
(12) Patent Application Publication
(10) Pub. No.: US 2026/0084356 A1
(43) Pub. Date: Mar. 26, 2026

(54) MOLDING MANAGEMENT SYSTEM

(71) Applicant: SEIKO EPSON CORPORATION, Tokyo (JP)

(72) Inventors: Kosuke ATSUTA, SHIOJIRI-SHI (JP); Tatsuo AKASAKA, AZUMINO-SHI (JP); Tomohiro TAKIZAWA, MATSUMOTO-SHI (JP)

(21) Appl. No.: 19/339,608

(22) Filed: Sep. 25, 2025

(30) Foreign Application Priority Data
Sep. 26, 2024 (JP) 2024-167216

(51) Int. Cl. B29C 45/76

(52) U.S. Cl. CPC B29C 45/768; B29C 2045/7606; B29C 2945/76163; B29C 2945/76943

(57) ABSTRACT

A molding management system includes an information processing device, and the information processing device acquires, for each cycle, cycle data including one or more pieces of cycle-related information and first date-and-time information, and displays, in response to a received operation, a data display image displaying a list of one or more pieces of the cycle data, that are acquired, arranged in order of date and time on a display unit, each of the one or more pieces of cycle-related information includes feature value information indicating a feature value of a quantity detected for each cycle by a detection unit attached to an injection molding apparatus, and according to the feature value information of the cycle data contained in the list, the information processing device displays, in the data display image, abnormality occurrence notification information notifying that an abnormality occurs in the cycle, and indicates, in the data display image, a degree of the abnormality that occurs in the cycle.

The present application is based on, and claims priority from JP Application Serial Number 2024-167216, filed September 26, 2024, the disclosure of which is hereby incorporated by reference herein in its entirety.

### BACKGROUND

### 1. Technical Field

The present disclosure relates to a molding management system.

### 2. Related Art

A technique for managing production of a product in a production process including an injection molding process of the product performed by an injection molding apparatus, has been studied and developed.

Here, there is known a technique for causing a user to confirm an abnormality that occurs in a cycle of injection molding in an injection molding apparatus and a content of the abnormality that has occurred (see JP-A-07-060815).

JP-A-07-060815 is an example of the related art.

However, in the technique described in JP-A-07-060815, the user can confirm the abnormality that has occurred in the cycle of the injection molding in the injection molding apparatus and the content of the abnormality that has occurred, but when a plurality of abnormalities occur, it may be difficult to grasp a priority order of a countermeasure for each of the plurality of abnormalities. This is not desirable since the countermeasures for the plurality of occurring abnormalities cannot be efficiently performed.

### SUMMARY

An aspect of the disclosure is a molding management system that manages production of a product in a production process including an injection molding process of the product performed by an injection molding apparatus, the molding management system including an information processing device communicably connected to a terminal device, in which the information processing device acquire, for each cycle of executing injection molding, cycle data including one or more pieces of cycle-related information obtained in response to execution of the cycle by the injection molding apparatus and first date-and-time information indicating a date and time when the cycle data is acquired from the injection molding apparatus, and displays, in response to a received operation, a data display image displaying a list of one or more pieces of the cycle data, that are acquired, arranged in order of the date and time on a display unit, each of the one or more pieces of cycle-related information includes feature value information indicating a feature value of a quantity detected for each cycle by a detection unit attached to the injection molding apparatus, and according to the feature value information of the cycle data contained in the list, the information processing device displays, in the data display image, abnormality occurrence notification information notifying that an abnormality occurs in the cycle, and indicates, in the data display image, a degree of the abnormality that occurs in the cycle.

### BRIEF DESCRIPTION OF THE DRAWINGS

FIG. 1 is a diagram showing an example of a configuration of a molding management system 1.

FIG. 2 is a diagram showing an example of a search image P1.

FIG. 3 is a diagram illustrating a method of specifying injection molding condition data to be associated with cycle data.

FIG. 4 is a diagram showing an example of the search image P1 in which a search result list is displayed in a search result display region R1.

FIG. 5 is a diagram showing an example of the search image P1 in which abnormality occurrence notification information is displayed.

FIG. 6 is a diagram showing an example of a condition designation image P2.

FIG. 7 is a diagram showing a first example of a state of the search result display region R1 in which abnormality degree information is displayed together with the abnormality occurrence notification information.

FIG. 8 is a diagram showing a second example of the state of the search result display region R1 in which the abnormality degree information is displayed together with the abnormality occurrence notification information.

FIG. 9 is a diagram showing a third example of the state of the search result display region R1 in which the abnormality degree information is displayed together with the abnormality occurrence notification information.

FIG. 10 is a diagram showing a fourth example of the state of the search result display region R1 in which the abnormality degree information is displayed together with the abnormality occurrence notification information.

FIG. 11 is a diagram showing a fifth example of the state of the search result display region R1 in which the abnormality degree information is displayed together with the abnormality occurrence notification information.

FIG. 12 is a diagram for comparing the abnormality occurrence notification information having different colors.

FIG. 13 is a diagram showing a modification of the search result display region R1 shown in FIG. 11.

FIG. 14 is a diagram showing a modification of the search result display region R1 shown in FIG. 9.

FIG. 15 is a diagram showing an example of a condition designation image P3.

FIG. 16 is a diagram showing an example of a condition designation image P4.

FIG. 17 is a diagram showing an example of a hardware configuration of an information processing device X.

FIG. 18 is a diagram showing an example of a functional configuration of the information processing device X.

FIG. 19 is a diagram showing an example of a flow of a process performed by the information processing device X in response to an operation received via the search image P1.

### DESCRIPTION OF EMBODIMENTS

### Embodiment

An embodiment of the disclosure will be described below with reference to the drawings.

### Overview of Molding Management System

First, an overview of a molding management system according to the embodiment will be described.

The molding management system according to the embodiment manages production of a product in a production process including an injection molding process of the product performed by an injection molding apparatus. The molding management system includes an information processing device. The information processing device is communicably connected to a terminal device. The information processing device acquires, for each cycle of executing injection molding, cycle data including one or more pieces of cycle-related information obtained in response to execution of the cycle by the injection molding apparatus and first date-and-time information indicating a date and time when the cycle data is acquired from the injection molding apparatus. The information processing device displays, in response to a received operation, a data display image displaying a list of one or more pieces of the cycle data, that are acquired, arranged in order of the date and time on a display unit. Here, each of the one or more pieces of cycle-related information includes feature value information indicating a feature value of a quantity detected for each cycle by a detection unit attached to the injection molding apparatus. Then, according to the feature value information of the cycle data contained in the list, the information processing device displays, in the data display image, abnormality occurrence notification information notifying that an abnormality occurs in the cycle, and indicates, in the data display image, a degree of the abnormality that occurs in the cycle. Accordingly, the molding management system can efficiently perform the countermeasure for the abnormality that occurs in the cycle.

In the following description, a configuration of the molding management system according to such an embodiment and processing performed by a server provided in the molding management system will be described in detail.

### Configuration of Molding Management System

Hereinafter, the configuration of the molding management system according to the embodiment will be described by taking a molding management system 1 as an example.

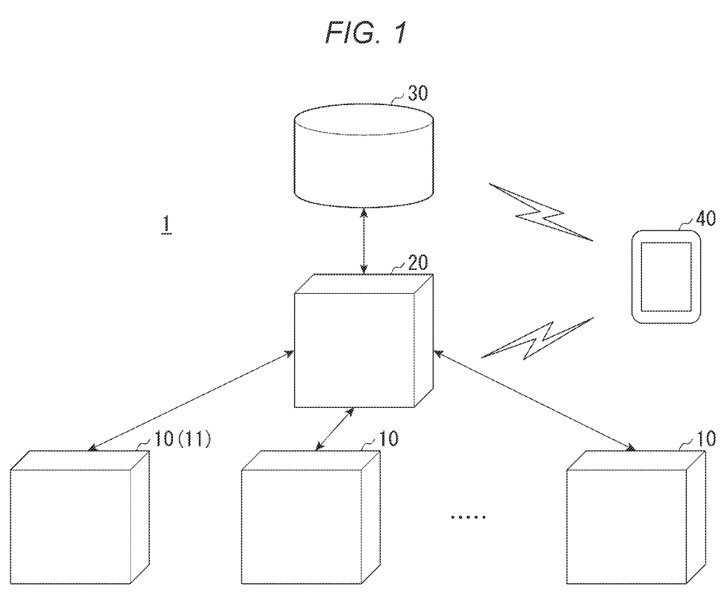

FIG. 1 is a diagram showing an example of a configuration of the molding management system 1.

The molding management system 1 is a type of manufacturing execution system (MES). For example, the molding management system 1 includes one or more managed devices 10, an information processing device 20, and a server 30. The molding management system 1 may not include a part or all of the one or more managed devices 10. The molding management system 1 may include the server 30 without including the information processing device 20. The molding management system 1 may include the information processing device 20 without including the server 30. In the molding management system 1, the information processing device 20 may be configured integrally with the server 30. Hereinafter, as an example, a case in which the molding management system 1 includes a plurality of managed devices 10 as the one or more managed devices 10 will be described. Hereinafter, as an example, a case in which the molding management system 1 includes both the information processing device 20 and the server 30 separate from the information processing device 20 will be described. At least one of the information processing device 20 and the server 30 is an example of the information processing device.

Each of the plurality of managed devices 10 provided in the molding management system 1 is a device managed by the molding management system 1. In FIG. 1, for convenience of description, the plurality of managed devices 10 are indicated by the same reference numeral. However, a part or all of the plurality of managed devices 10 may be devices of types different from one another. The plurality of managed devices 10 include at least one injection molding apparatus that performs injection molding of a product using resin such as plastic. An injection molding apparatus 11 shown in FIG. 1 is an example of such an injection molding apparatus. The plurality of managed devices 10 may include an injection molding apparatus that performs metal injection molding (MIM) of a product. Hereinafter, for convenience of description, injection molding of a product using resin such as plastic is simply referred to as injection molding. Hereinafter, the injection molding apparatus that performs the injection molding of a product using a resin such as plastic is simply referred to as an injection molding apparatus. In addition to the injection molding apparatus, the plurality of managed devices 10 include, for example, peripheral equipment of the injection molding apparatus. Examples of the peripheral equipment of the injection molding apparatus include, but are not limited to, a material supply device that supplies, to the injection molding apparatus, a material used for the injection molding of a product performed by the injection molding apparatus, a conveying device that conveys the product injection-molded by the injection molding apparatus, a cleaning device that cleans the product injection-molded by the injection molding apparatus, and a sintering device that sinters the product cleaned by the cleaning device. At least one injection molding apparatus in the plurality of managed devices 10 may be a device that performs injection molding using a material other than resin and metal.

The molding management system 1 manages production of a product in a production process including an injection molding process of the product performed by the injection molding apparatus included in the plurality of managed devices 10. The injection molding apparatus included in the plurality of managed devices 10 may have any configuration as long as the configuration is capable of producing a product by injection molding. Hereinafter, for convenience of description, a process in which the injection molding apparatus performs injection molding of a product once is referred to as a cycle.

The information processing device 20 acquires cycle data for each cycle from each of the one or more injection molding apparatuses included in the plurality of managed devices 10. More specifically, the information processing device 20 acquires the cycle data from each of the one or more injection molding apparatuses every time each cycle ends. Here, the cycle data acquired from a certain injection molding apparatus in a certain cycle is information including one or more pieces of cycle-related information obtained in response to the execution of the cycle by the injection molding apparatus, apparatus identification information for identifying the injection molding apparatus and first date-and-time information indicating a date and time when the cycle data is acquired by the information processing device 20 from the injection molding apparatus. The cycle data may include other information in addition to the one or more pieces of cycle-related information, the apparatus identification information, and the first date-and-time information. The apparatus identification information is, for example, an identifier (ID) for identifying the injection molding apparatus, but may be other information capable of identifying the injection molding apparatus, such as an Internet Protocol (IP) address assigned to the injection molding apparatus. The apparatus identification information may be contained in the one or more pieces of cycle-related information. Hereinafter, as an example, a case in which the apparatus identification information is contained in the one or more pieces of cycle-related information will be described. In this case, the one or more pieces of cycle-related information include at least one or more pieces of feature value information in addition to the apparatus identification information. The one or more pieces of cycle-related information may include other information in addition to the apparatus identification information and the one or more pieces of feature value information. The other information is, for example, a part or all of operation state information, product quantity information, and the like, but is not limited thereto. The one or more pieces of feature value information contained in the cycle data as the cycle-related information are information indicating feature values of quantities detected respectively by one or more various detection units attached to the injection molding apparatus. The detection unit that detects a certain quantity is, for example, a sensor that detects the quantity, but is not limited thereto. The one or more pieces of feature value information are, for example, a part or all of information indicating a feature value of a temperature, information indicating a feature value of a pressure, information indicating a feature value of a current value, information indicating a feature value of a voltage value, and the like, but are not limited thereto. The one or more various detection units may include a detection unit that detects a quality of the product. In this case, the detection unit is, for example, a device that includes an imaging unit capable of imaging the product to detect the quality of the product, but is not limited thereto. In this case, the feature value information contained in the cycle data as the cycle-related information includes quality information indicating the quality of the product. For example, a quantity indicating a quality of the product detected by the detection unit is, for example, any of a plurality of predetermined values arranged in descending order of quality, but is not limited thereto. Here, a feature value of a certain quantity is a value indicating a feature of the quantity, and is, for example, a statistically processed value such as a maximum value or an average value, but is not limited thereto. The feature value information indicating the feature value of the quantity may be the feature value or may be information indicating a time series of the quantity. The operation state information contained in the cycle data as the cycle-related information is information indicating an operation state of the injection molding apparatus. The product quantity information contained in the cycle data as the cycle-related information is information indicating a quantity of products injection-molded in the cycle. The first date-and-time information indicating the date and time when the cycle data is acquired by the information processing device 20 from the injection molding apparatus may be a time stamp or other information indicating the date and time. Each piece of the cycle data including such information can be discriminated by a combination of the apparatus identification information and the first date-and-time information. When there is only one injection molding apparatus connected to the information processing device 20, the cycle data may not include the apparatus identification information. This is because, in this case, the cycle data can be discriminated simply by the first date-and-time information. When a certain piece of cycle data is acquired, the information processing device 20 stores the acquired cycle data and outputs the acquired cycle data to the server 30. Accordingly, the information processing device 20 can also store the acquired cycle data in the server 30.

Further, the information processing device 20 acquires injection molding condition data from each of the one or more injection molding apparatuses included in the plurality of managed devices 10 every time an injection molding condition is set in the injection molding apparatus. Here, the injection molding condition data acquired from a certain injection molding apparatus is information in which one or more pieces of injection molding condition information each indicating the injection molding condition set in the injection molding apparatus, the apparatus identification information for identifying the injection molding apparatus, and second date-and-time information indicating a date and time when the injection molding condition data is acquired by the information processing device 20 from the injection molding apparatus are associated with one another. The injection molding condition data may include other information in addition to the one or more pieces of injection molding condition information, the apparatus identification information, and the second date-and-time information. The apparatus identification information is, for example, an ID for identifying the injection molding apparatus, but may be other information capable of identifying the injection molding apparatus, such as an IP address assigned to the injection molding apparatus. The apparatus identification information may be contained in the one or more pieces of injection molding condition information. Hereinafter, as an example, a case in which the apparatus identification information is contained in the one or more pieces of injection molding condition information will be described. In this case, the one or more pieces of injection molding condition information include, in addition to the apparatus identification information, a part or all of, for example, information indicating an injection speed, information indicating a rotation speed of a screw, information indicating a lower limit value of an injection holding pressure, and information indicating an upper limit value of the injection holding pressure. However, the information contained in the one or more pieces of injection molding condition information is not limited thereto. The second date-and-time information indicating the date and time when the injection molding condition data is acquired by the information processing device 20 from the injection molding apparatus may be a time stamp or other information indicating the date and time. When a certain piece of injection molding condition data is acquired, the information processing device 20 stores the acquired injection molding condition data and outputs the acquired injection molding condition data to the server 30. Accordingly, the information processing device 20 can also store the acquired injection molding condition data in the server 30. The information processing device 20 may be configured not to acquire the injection molding condition data. In this case, the server 30 does not acquire the injection molding condition data from the information processing device 20.

In response to a request from a terminal device communicably connected to the information processing device 20, the information processing device 20 displays, on a display unit of the terminal device, various images based on the data stored in the information processing device 20. Here, the images are a graphical user interface (GUI), an icon, a window on an operating system (OS), and the like. Hereinafter, as an example, a case in which the information processing device 20 is communicably connected to the terminal device 40 as shown in FIG. 1 will be described. In the present embodiment, since processing related to login to the information processing device 20 via the terminal device 40 is known processing, a description thereof will be omitted. Hereinafter, for convenience of description, the information processing device 20 receiving an operation from the terminal device 40 via an image displayed on the terminal device 40 is simply referred to as the information processing device 20 receiving an operation. That is, hereinafter, the information processing device 20 performing a certain process in response to a received operation means the information processing device 20 performing the process in response to an operation received from the terminal device 40 via the image displayed on the terminal device 40.

Examples of the information processing device 20 include, but are not limited to, a workstation, a desktop PC (Personal Computer), and a notebook PC. The information processing device 20 is communicably connected to each of the plurality of managed devices 10 by wired or wireless communication. Examples of a communication network that connects the information processing device 20 and each of the plurality of managed devices 10 include, but are not limited to, a Local Area Network (LAN) in a facility in which a plurality of managed devices 10 are installed. The communication network may be another communication network such as the Internet or a mobile communication network.

The server 30 stores the cycle data acquired by the information processing device 20. For example, when a certain piece of cycle data is acquired from the information processing device 20, the server 30 stores the acquired cycle data.

The server 30 stores the injection molding condition data acquired by the information processing device 20. For example, when a certain piece of injection molding condition data is acquired from the information processing device 20, the server 30 stores the acquired injection molding condition data.

In response to a request from a terminal device communicably connected to the server 30, the server 30 displays, on a display unit of the terminal device, various images based on the data stored in the server 30. Here, the images are the GUI, the icon, the window on the OS, and the like. Hereinafter, as an example, a case in which the server 30 is communicably connected to the terminal device 40 as shown in FIG. 1 will be described. In the present embodiment, since processing related to login to the server 30 via the terminal device 40 is known processing, a description thereof will be omitted. Hereinafter, for convenience of description, the server 30 receiving an operation from the terminal device 40 via an image displayed on the terminal device 40 is simply referred to as the server 30 receiving an operation. That is, hereinafter, the server 30 performing a certain process in response to a received operation means the server 30 performing the process in response to an operation received from the terminal device 40 via the image displayed on the terminal device 40.

As described above, in the molding management system 1, both the information processing device 20 and the server 30 display, in response to the received operation, various images based on the stored data on the display unit of the terminal device 40. Therefore, hereinafter, for convenience of description, the information processing device 20 and the server 30 are collectively referred to as an information processing device X unless it is necessary to distinguish them. Examples of the display unit include, but are not limited to, a display of the terminal device 40 and a display device communicably connected to the terminal device 40. Hereinafter, as an example, a case in which the display unit is the display of the terminal device 40 will be described. Hereinafter, for convenience of description, displaying a certain image on the display unit is referred to as displaying an image.

The information processing device X displays, in response to a received operation, a search image P1 for searching for one or more pieces of cycle data desired by a user among the one or more pieces of cycle data stored in the information processing device X. The search image P1 is an image for receiving various types of information that can be used as a search key for searching for the one or more pieces of cycle data desired by the user. Hereinafter, in order to simplify the description, as an example, a case will be described in which the search image P1 can receive, as the search key, each of the apparatus identification information for identifying the injection molding apparatus that outputs the cycle data and period information indicating a period including the date and time when the cycle data is acquired by the information processing device 20.

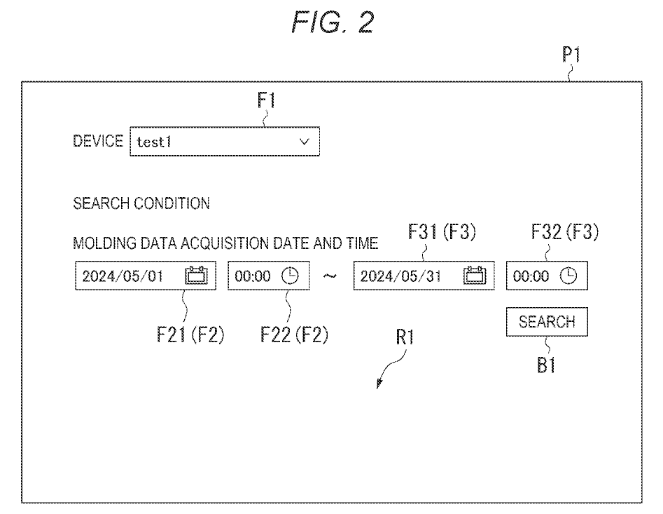

FIG. 2 is a diagram showing an example of the search image P1. In the example shown in FIG. 2, the search image P1 includes an input field F1, an input field F2, an input field F3, a button B1, and a search result display region R1. The search image P1 may include another graphical user interface (GUI) capable of receiving an operation of searching for the cycle data instead of a part or all of these GUIs or in addition to all of these GUIs. Hereinafter, for convenience of description, various operations received by the information processing device X via the search image P1 are collectively referred to as search operations.

The input field F1 is a field for inputting the apparatus identification information for identifying the injection molding apparatus that outputs the cycle data desired by the user. In the example shown in FIG. 2, "test 1" is input to the input field F1 as an example of the apparatus identification information. The apparatus identification information may be input to the input field F1 by selecting the apparatus identification information from a pull-down menu or may be directly input using an input device such as a keyboard.

The input field F2 and the input field F3 are fields for inputting the period information indicating a period including a date and time desired by the user to acquire the cycle data via the information processing device 20. In the example shown in FIG. 2, the input field F2 is a field for inputting start date-and-time information indicating a date and time when the period starts. In this example, the input field F3 is a field for inputting end date-and-time information indicating a date and time when the period ends.

More specifically, the input field F2 includes two input fields, that is, an input field F21 and an input field F22. The input field F21 is a field for inputting start date information indicating a date in the date and time indicated by the start date-and-time information. In the example shown in FIG. 2, in the input field F21, "2024/05/01" indicating May 7, 2024, is input as an example of the start date information. The start date information may be input to the input field F21 by selecting information from a pull-down menu, may be input by selecting a date from an image indicating a calendar, or may be directly input using an input device such as a keyboard. Meanwhile, the input field F22 is a field for inputting start time information indicating a time in the date and time indicated by the start date-and-time information. In the input field F22, "00:00" indicating zero o'clock is input as an example of the start time information. The start time information may be input to the input field F22 by selecting information from a pull-down menu, may be input by designating a time on an image indicating a clock, or may be directly input using an input device such as a keyboard.

The input field F3 includes two input fields, that is, an input field F31 and an input field F32. The input field F31 is a field for inputting end date information indicating a date in the date and time indicated by the end date-and-time information. In the example shown in FIG. 2, in the input field F31, "2024/05/31" indicating May 8, 2024 is input as an example of the end date information. The end date information may be input to the input field F31 by selecting information from a pull-down menu, may be input by selecting a date from an image indicating a calendar, or may be directly input using an input device such as a keyboard. Meanwhile, the input field F32 is a field for inputting end time information indicating a time in the date and time indicated by the end date-and-time information. In the input field F32, "00:00" indicating zero o'clock is input as an example of the end time information. The end time information may be input to the input field F32 by selecting information from a pull-down menu, may be input by designating a time on an image indicating a clock, or may be directly input using an input device such as a keyboard.

The button B1 is a button for receiving an operation of using each piece of information input to a part or all of the input field F1 to the input field F3 as the search key to search for the cycle data based on the search key. That is, when a selection operation on the button B1 is received, the information processing device X extracts, as a search result, one or more pieces of cycle data corresponding to the respective pieces of information input to a part or all of the input field F1 to the input field F3. Then, the information processing device X displays a list of the extracted one or more pieces of cycle data in the search result display region R1. In the present embodiment, the selection operation means a click, a tap, or the like, but is not limited thereto. The search image P1 shown in FIG. 2 is an image before the one or more pieces of cycle data are extracted. Therefore, nothing is displayed in the search result display region R1 shown in FIG. 2. Hereinafter, for convenience of description, the list of one or more pieces of cycle data extracted by the information processing device X is simply referred to as a search result list. A method of extracting one or more pieces of cycle data corresponding to the respective pieces of information input to a part or all of the input field F1 to the input field F3, that is, a method of searching for the one or more pieces of cycle data may be a known method or a method to be developed in the future. Therefore, in the present embodiment, a detailed description of the extraction method will be omitted. When no information is input to all of the input field F1 to the input field F3 and a selection operation is performed on the button B1, the information processing device X may be configured to display a list of all of the one or more pieces of cycle data stored in advance in the search result display region R1 as the search result list, or may be configured to display nothing in the search result display region R1.

When displaying the search result list in the search result display region R1 in this manner, the information processing device X extracts, for each of the one or more pieces of cycle data extracted as the search result, the injection molding condition data corresponding to the cycle data from among the one or more pieces of injection molding condition data stored in advance, and associates the extracted injection molding condition data with the cycle data. At this time, the information processing device X associates one piece of injection molding condition data with one piece of cycle data. That is, the information processing device X associates the cycle data with the injection molding condition data in a one-to-one or many-to-one relationship. Therefore, when the search result list is displayed in the search result display region R1, each piece of cycle data is associated with one piece of injection molding condition data.

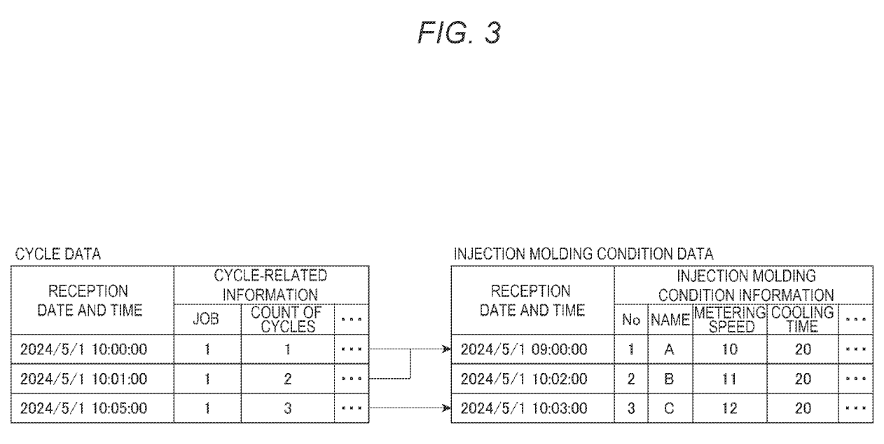

Here, a method of specifying the injection molding condition data associated with each piece of cycle data will be described. When specifying the injection molding condition data to be associated with a certain piece of cycle data, the information processing device X extracts, from among the one or more pieces of injection molding condition data stored in advance, one or more pieces of injection molding condition data including the apparatus identification information contained in the cycle data. Then, the information processing device X specifies, from among the extracted one or more injection molding condition data, the injection molding condition data including the second date-and-time information indicating a past date and time closest to the date and time indicated by the first date-and-time information contained in the cycle data, as the injection molding condition data to be associated with the cycle data. FIG. 3 is a diagram illustrating a method of specifying the injection molding condition data to be associated with the cycle data. FIG. 3 shows three pieces of cycle data output from a certain injection molding apparatus and three pieces of injection molding condition data output from the injection molding apparatus. Specifically, FIG. 3 shows three pieces of cycle data, that is, cycle data containing first date-and-time information indicating 10:00:00 on May 1, 2024, cycle data including first date-and-time information indicating 10:01:00 on May 1, 2024, and cycle data including first date-and-time information indicating 10:05:00 on May 1, 2024. Meanwhile, FIG. 3 shows three pieces of injection molding condition data, that is, injection molding condition data including second date-and-time information indicating 09:00:00 on May 1, 2024, injection molding condition data including second date-and-time information indicating 10:02:00 on May 1, 2024, and injection molding condition data including second date-and-time information indicating 10:03:00 on May 1, 2024. For example, when the three pieces of cycle data shown in FIG. 3 are extracted by the information processing device X in the search image P1 and the three pieces of injection molding condition data shown in FIG. 3 are stored in advance in the information processing device X, the information processing device X specifies the injection molding condition data to be associated with the three pieces of cycle data, from among the three pieces of injection molding condition data. Specifically, the information processing device X specifies, as the injection molding condition data to be associated with the cycle data including the first date-and-time information indicating 10:00:00 on May 1, 2024, the injection molding condition data including the second date-and-time information indicating 09:00:00 on May 1, 2024. This is because, among the three dates and times, that is, 09:00:00 on May 1, 2024, 10:02:00 on May 1, 2024, and 10:03:00 on May 1, 2024, a date and time closest to 10:00:00 on May 1, 2024 is 09:00:00 on May 1, 2024. Similarly, the information processing device X specifies, as the injection molding condition data to be associated with the cycle data including the first date-and-time information indicating 10:01:00 on May 1, 2024, the injection molding condition data including the second date-and-time information indicating 09:00:00 on May 1, 2024. Then, the information processing device X specifies, as the injection molding condition data to be associated with the cycle data including the first date-and-time information indicating 10:05:00 on May 1, 2024, the injection molding condition data including the second date-and-time information indicating 10:03:00 on May 1, 2024. Therefore, in this case, the information processing device X does not specify the injection molding condition data including the second date-and-time information indicating 10:02:00 on May 1, 2024, as the injection molding condition data to be associated with any of the three pieces of cycle data shown in FIG. 3. Accordingly, the information processing device X can omit unnecessary injection molding condition data and associate the injection molding condition data necessary for the user with the cycle data. This is because, for example, when an abnormality occurs in the product injection-molded by the injection molding apparatus, the user can easily grasp the situation, and as a result, a cause of the abnormality occurring in the product can be easily specified. By the specifying method as described above, the information processing device X can associate one piece of injection molding condition data with each of the three pieces of cycle data shown in FIG. 3. As a result, when the information processing device X displays the search result list in the search result display region R1, one piece of injection molding condition data is associated with each piece of cycle data. In FIG. 3, the injection molding condition data is connected, by an arrow, to each piece of cycle data associated therewith. That is, in the example shown in FIG. 3, the information processing device X can associate one piece of injection molding condition data with one piece of cycle data. However, this also means that there may be a plurality of pieces of cycle data associated with a certain piece of injection molding condition data. For example, when an abnormality occurs in the quality of the product molded by injection molding, the user often specifies a cause of the abnormality while viewing the cycle data. Therefore, even if the cycle data and the injection molding condition data are associated with each other in a many-to-one relationship, the information processing device X can prevent work required to specify the cause of the abnormality from being complicated as long as the number of pieces of injection molding condition data associated with each piece of cycle data is one. Therefore, the information processing device X associates one piece of injection molding condition data with one piece of cycle data instead of associating a plurality of pieces of injection molding condition data with one piece of cycle data. Further, for example, usually, the injection molding condition set in the injection molding apparatus is not changed during execution of the cycle. Therefore, even if the injection molding condition is set in the injection molding apparatus a plurality of times before the cycle is executed, the injection molding condition set in the injection molding apparatus during actual execution of the cycle is the injection molding condition set in the injection molding apparatus last before the execution of the cycle is started. Under such circumstances, when the injection molding apparatus outputs a certain piece of cycle data, the injection molding condition set in the injection molding apparatus at the time of outputting the cycle data is the injection molding condition indicated by the injection molding condition data including the second date-and-time information indicating a past date and time closest to the date and time indicated by the first date-and-time information contained in the cycle data. Therefore, the information processing device X associates the cycle data with the injection molding condition data by the method described above. The injection molding condition in the injection molding apparatus is set a plurality of times before the execution of the cycle when an erroneous injection molding condition is set in the injection molding apparatus, when the injection molding condition is changed for some reason, when a trial and error for obtaining a better injection molding condition is executed, or the like. The association between the cycle data and the injection molding condition data may be performed in the information processing device X every time the cycle data is stored in the information processing device X. In this case, when the search result list is displayed in the search result display region R1, one piece of injection molding condition data is already associated with each piece of cycle data extracted as the search result. Therefore, in this case, the information processing device X does not associate the cycle data with the injection molding condition data when displaying the search result list in the search result display region R1.

After each of the extracted one or more pieces of cycle data is associated with one piece of injection molding condition data, the information processing device X displays, in the search result display region R1, association information indicating the injection molding condition data associated with each piece of cycle data, together with the corresponding piece of cycle data contained in the search result list. That is, in the search result display region R1, each piece of cycle data is displayed in the search result display region R1 together with the association information indicating the injection molding condition data associated with the corresponding piece of cycle data. Hereinafter, as an example, a case in which the association information displayed in the search result display region R1 together with a certain piece of cycle data is an image indicating the injection molding condition data associated with the cycle data will be described. The association information may be information other than the image. The association information may be information including at least a part of the injection molding condition data.

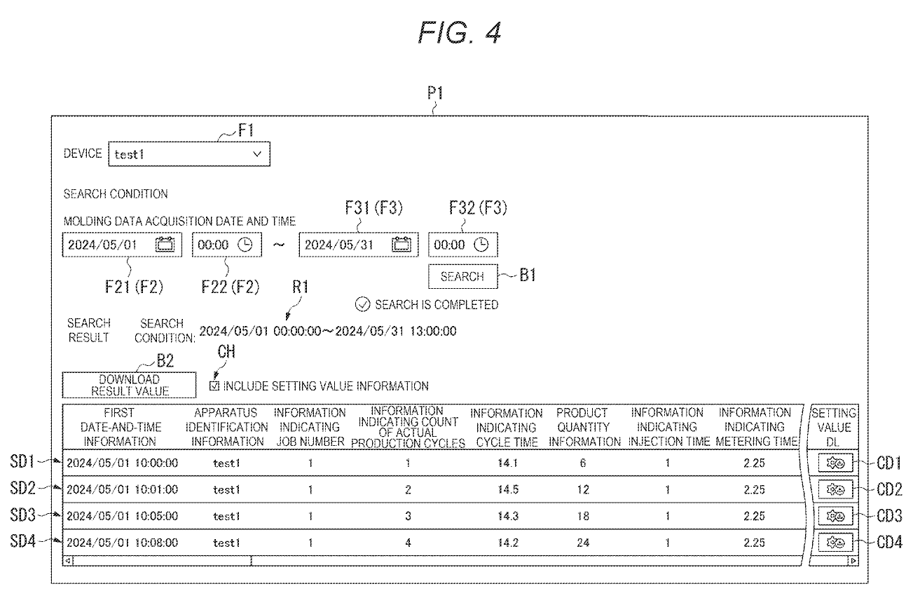

FIG. 4 is a diagram showing an example of the search image P1 in which the search result list is displayed in the search result display region R1. In the example shown in FIG. 4, in the search result display region R1, a search result list including four pieces of cycle data, that is, cycle data SD1 to cycle data SD4 is displayed. In addition to the first date-and-time information and the apparatus identification information, each of the four pieces of cycle data includes, as the cycle-related information, information indicating a job number, information indicating the number of actual production cycles, information indicating a cycle time, the product quantity information, information indicating an injection time, information indicating a metering time, and the like. Further, in the search result display region R1, the association information indicating the injection molding condition associated with each piece of cycle data is displayed in association with a corresponding piece of the four pieces of cycle data. That is, in the search result display region R1, association information CD1 is displayed in association with the cycle data SD1. The association information CD1 is association information indicating the injection molding condition data associated with the cycle data SD1. In the search result display region R1, association information CD2 is displayed in association with the cycle data SD2. The association information CD2 is association information indicating the injection molding condition data associated with the cycle data SD2. In the search result display region R1, association information CD3 is displayed in association with the cycle data SD3. The association information CD3 is association information indicating the injection molding condition data associated with the cycle data SD3. In the search result display region R1, association information CD4 is displayed in association with the cycle data SD4. The association information CD4 is association information indicating the injection molding condition data associated with the cycle data SD4. In this way, when displaying the search result list in the search result display region R1, the information processing device X displays the association information indicating the injection molding condition data associated with respective pieces of cycle data contained in the search result list in the search result display region R1 together with the respective pieces of cycle data. Accordingly, the information processing device X can make it possible to easily grasp a relation between the cycle of the injection molding in the injection molding apparatus and the injection molding condition set in the injection molding apparatus. In the example shown in FIG. 4, the association information indicating the injection molding condition data associated with the corresponding piece of cycle data is an image not including the injection molding condition data itself. Therefore, in this example, the user cannot visually grasp the injection molding condition data associated with the corresponding piece of cycle data simply by the information displayed in the search result display region R1 shown in FIG. 4. Therefore, as described above, each piece of association information may include at least a part of the injection molding condition data indicated by the association information. In this case, the user can visually grasp the injection molding condition data associated with the corresponding piece of cycle data simply by the information displayed in the search result display region R1. As a result, the information processing device X can make it possible to more reliably and easily grasp the relation between the cycle of injection molding in the injection molding apparatus and the injection molding condition set in the injection molding apparatus.

Here, in the example shown in FIG. 4, each of the association information CD1 to the association information CD4 is an image for receiving an operation of outputting the injection molding condition data indicated by a corresponding piece of the association information to another device. The other device may be, for example, the terminal device 40 or another information processing device communicably connected to the information processing device X. For example, when a selection operation on the association information CD1 is received, the information processing device X outputs the injection molding condition data associated with the cycle data SD1 to the terminal device 40 as the injection molding condition data indicated by the association information CD1. Accordingly, the user can easily download the injection molding condition data to the terminal device 40. The same also applies to each of the association information CD2 to the association information CD4. In this way, by outputting the injection molding condition data to the terminal device 40 by an operation on the association information in this way, when the user wants to acquire desired injection molding condition data, it is not necessary to search for the desired injection molding condition data from among many pieces of injection molding condition data, and the desired injection molding condition data can be easily acquired. This is also useful to prevent the user from acquiring erroneous injection molding condition data. For example, the information processing device X outputs the injection molding condition data to the terminal device 40 as a CSV (Comma Separated Values) file, but is not limited thereto.

As shown in FIG. 4, when displaying the search result list in the search result display region R1, the information processing device X displays the search result list in the search result display region R1 in order of the date and time indicated by the first date-and-time information contained in each piece of cycle data. Specifically, in the search result display region R1 shown in FIG. 4, the four pieces of cycle data are displayed in ascending order of date and time. Accordingly, the information processing device X can confirm the plurality of pieces of cycle data displayed in the search result display region R1 in chronological order. In the search result display region R1, a plurality of pieces of cycle data may be displayed in descending order of date and time.

Further, the information processing device X displays the abnormality occurrence notification information notifying that an abnormality occurs in the cycle in the search image P1 according to the feature value information of the cycle data contained in the search result list. The search image P1 is an example of the data display image. Here, the abnormality occurring in the cycle includes, for example, at least one of an abnormality occurring in the injection molding apparatus, an abnormality occurring in a mold attached to the injection molding apparatus, and an abnormality occurring in the quality of the product injection-molded by the injection molding apparatus. The abnormality occurring in the injection molding apparatus is an abnormality that may affect the quality of the product and is an abnormality that may lead to damage to the injection molding apparatus. The abnormality occurring in the mold attached to the injection molding apparatus is an abnormality that may affect the quality of the product and is an abnormality that may lead to damage to the mold. The abnormality occurring in the quality of the product injection-molded by the injection molding apparatus is an abnormality that may occur in response to the abnormality occurring in at least one of the injection molding apparatuses and the mold but may also occur regardless of the abnormality occurring in both the injection molding apparatus and the mold. Therefore, a countermeasure for the abnormality occurring in the cycle varies depending on one or more occurring abnormalities among the abnormality occurring in the injection molding apparatus, the abnormality occurring in the mold attached to the injection molding apparatus, and the abnormality occurring in the quality of the product injection-molded by the injection molding apparatus. In other words, a degree of the abnormality occurring in the cycle varies depending on one or more occurring abnormalities among the abnormality occurring in the injection molding apparatus, the abnormality occurring in the mold attached to the injection molding apparatus, and the abnormality occurring in the quality of the product injection-molded by the injection molding apparatus.

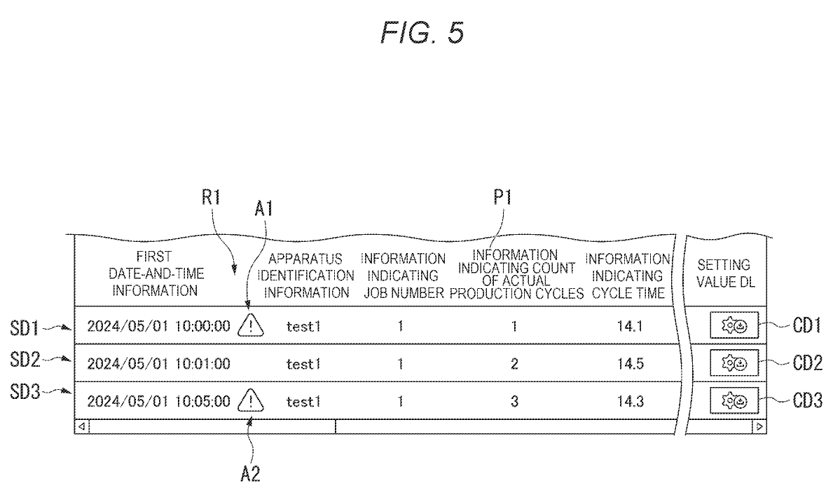

FIG. 5 is a diagram showing an example of the search image P1 in which the abnormality occurrence notification information is displayed. In the example shown in FIG. 5, in the search result display region R1, abnormality occurrence notification information A1 is displayed in association with the cycle data SD1. The abnormality occurrence notification information A1 indicates that an abnormality occurs in a cycle corresponding to the cycle data SD1. In this example, in the search result display region R1, abnormality occurrence notification information A2 is displayed in association with the cycle data SD3. The abnormality occurrence notification information A2 indicates that an abnormality occurs in a cycle corresponding to the cycle data SD3. On the other hand, in this example, no abnormality occurrence notification information in association with the cycle data SD2 is displayed. This indicates that no abnormality occurs in a cycle corresponding to the cycle data SD2. Accordingly, the information processing device X can easily specify a cycle in which some abnormality occurs.

Here, when at least one of feature values indicated by one or more pieces of feature value information contained in the cycle data corresponding to a certain cycle does not satisfy a monitoring condition determined in advance, the information processing device X determines that an abnormality occurs in the cycle. Therefore, the abnormality occurrence notification information is a mark displayed in association with the cycle data including the feature value information indicating the feature value not satisfying the monitoring condition determined in advance among the cycle data contained in the search result list. The monitoring condition is represented by a limit range determined in advance for each of the feature values indicated by one or more pieces of feature value information contained in the cycle data. Specifically, the monitoring condition for a feature value indicated by a certain piece of feature value information contained in the cycle data is that the feature value is not out of the limit range determined in advance for the feature value. Hereinafter, for convenience of description, a certain feature value not out of the limit range determined in advance for the feature value is referred to as the feature value satisfying the monitoring condition, and the feature value out of the limit range is referred to as the feature value not satisfying the monitoring condition. When all feature values indicated by one or more pieces of feature value information contained in a certain piece of cycle data satisfy respective monitoring conditions, the information processing device X does not display the abnormality occurrence notification information associated with the cycle data in the search result display region R1. On the other hand, when at least one of feature values indicated by one or more pieces of feature value information does not satisfy the monitoring condition, the information processing device X displays the abnormality occurrence notification information associated with the cycle data in the search result display region R1. That is, in the example shown in FIG. 5, in the cycle data SD1, at least one of the feature values indicated by the one or more pieces of feature value information contained in the cycle data SD1 does not satisfy the monitoring condition. Therefore, in this example, the information processing device X displays the abnormality occurrence notification information A1 in association with the cycle data SD1. On the other hand, in this example, in the cycle data SD2, all feature values indicated by one or more pieces of feature value information contained in the cycle data SD2 satisfy the respective monitoring conditions. Therefore, in this example, the information processing device X displays no abnormality occurrence notification information in association with the cycle data SD2 in the search result display region R1.

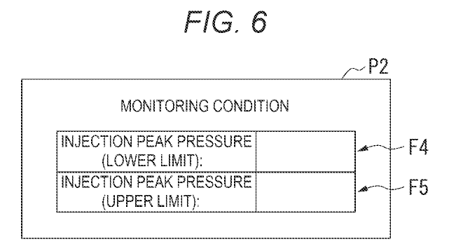

The information processing device X receives the limit range representing each monitoring condition, via a condition designation image P2 as shown in FIG. 6, for example. FIG. 6 is a diagram showing an example of the condition designation image P2. In FIG. 6, in order to simplify the description, a case in which the number of pieces of feature value information contained in each piece of cycle data is one will be described. Therefore, in the example shown in FIG. 6, the condition designation image P2 is an image for receiving the limit range for one feature value. In FIG. 6, as an example, a case in which the one feature value is an injection peak pressure will be described. In this case, a detection unit that detects an injection pressure is attached to the injection molding apparatus. The injection peak pressure is an example of the feature value of the injection pressure, and is a maximum value of the injection pressure. The detection unit is a sensor that detects the injection pressure, for example, a pressure sensor, but is not limited thereto. When receiving an operation determined in advance, the information processing device X displays the condition designation image P2.

When the limit range for the injection peak pressure is determined by a one-sided tolerance, the condition designation image P2 receives either an upper limit value or a lower limit value of the limit range. On the other hand, when the limit range for the injection peak pressure is determined by a two-sided tolerance, the condition designation image P2 receives both the upper limit value and the lower limit value of the limit range. In FIG. 6, as an example, a case in which the limit range is determined by the two-sided tolerance will be described. In this case, as shown in FIG. 6, the condition designation image P2 includes, for example, two input fields, that is, an input field F4 and an input field F5. The condition designation image P2 may include another GUI in addition to the two input fields.

The input field F4 is a field for receiving the lower limit value of the limit range for the injection peak pressure. In the example shown in FIG. 6, a value serving as the lower limit value is not input to the input field F4. The lower limit value may be input to the input field F4 by selecting the lower limit value from a pull-down menu, or may be directly input using an input device such as a keyboard.

The input field F5 is a field for receiving the upper limit value of the limit range for the injection peak pressure. In the example shown in FIG. 6, a value serving as the upper limit value is not input to the input field F5. The upper limit value may be input to the input field F5 by selecting the upper limit value from a pull-down menu, or may be directly input using an input device such as a keyboard.

When receiving the lower limit value and the upper limit value of the injection peak pressure via the condition designation image P2, the information processing device X stores a combination of the received lower limit value and upper limit value as the limit range for the injection peak pressure, that is, the monitoring condition for the injection peak pressure. In this way, the information processing device X receives, via the condition designation image P2, the monitoring condition for the feature value indicated by each of the one or more pieces of feature value information contained in each piece of cycle data. The monitoring condition for the feature value indicated by the feature value information contained in a certain piece of cycle data may be contained in the injection molding condition data associated with the cycle data. In this case, the monitoring condition for the feature value indicated by the feature value information contained in each piece of cycle data is set in the injection molding apparatus. In this case, the information processing device X may be configured not to display the condition designation image P2 or may be configured to display the condition designation image P2.

Here, when a plurality of pieces of abnormality occurrence notification information is simultaneously displayed as shown in FIG. 5, the user can easily specify in which cycle the abnormality occurs among the cycles corresponding to the cycle data displayed in the search result display region R1. However, in a display pattern of the abnormality occurrence notification information as shown in FIG. 5, it is difficult for the user to grasp a priority order regarding which abnormality among a plurality of abnormalities the countermeasure is to be performed for. This is because, in the example shown in FIG. 5, there is no difference other than the cycle data in association which the two pieces of abnormality occurrence notification information, that is, the abnormality occurrence notification information A1 and the abnormality occurrence notification information A2, and it is difficult for the user to read, from the two pieces of abnormality occurrence notification information, information other than information indicating that abnormalities occur in the two cycles.

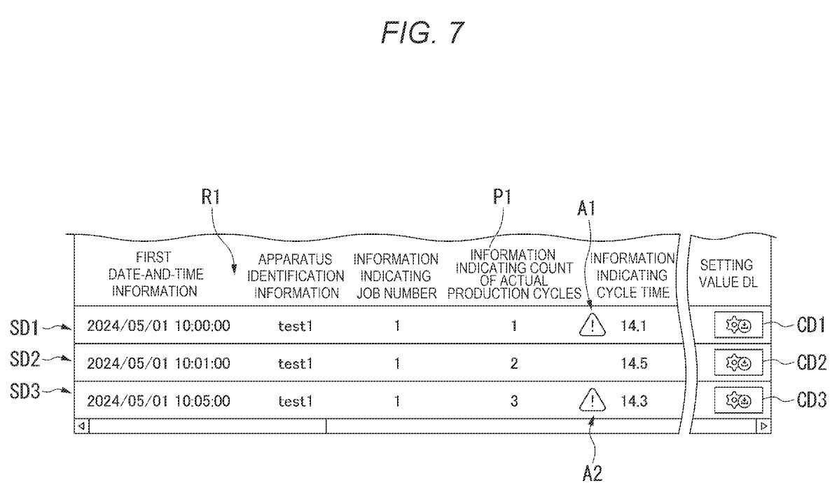

Therefore, the information processing device X displays the abnormality occurrence notification information and shows the degree of the abnormality occurring in the cycle in the search image P1. Hereinafter, for convenience of description, showing the degree is referred to as displaying abnormality degree information. FIG. 7 is a diagram showing a first example of a state of the search result display region R1 in which the abnormality degree information is displayed together with the abnormality occurrence notification information. That is, FIG. 7 is a diagram showing the state of the search result display region R1 in which the abnormality occurrence notification information is displayed and a state where the degree of the abnormality occurring in the cycle is shown in the search result display region R1. In the example shown in FIG. 7, the abnormality occurrence notification information A1 is displayed in association with cycle-related information indicating a cycle time among the one or more pieces of cycle-related information contained in the cycle data SD1. This means that the monitoring condition for the cycle time is not satisfied in the cycle corresponding to the cycle data SD1. In this example, the abnormality occurrence notification information A2 is displayed in association with cycle-related information indicating a cycle time among the one or more pieces of cycle-related information contained in the cycle data SD3. This means that the monitoring condition for the cycle time is also not satisfied in the cycle corresponding to the cycle data SD3.

In this way, when the abnormality occurrence notification information is displayed in association with at least one among the one or more pieces of cycle-related information contained in the cycle data, the user can determine whether to preferentially perform the countermeasure, according to an item of the cycle-related information displayed in association with the abnormality occurrence notification information. For example, in this case, the user can determine whether the abnormality occurring in the cycle is the abnormality occurring in the injection molding apparatus, the abnormality occurring in the mold attached to the injection molding apparatus, or the abnormality occurring in the quality of the product injection-molded by the injection molding apparatus. That is, in the example shown in FIG. 7, a position of the abnormality occurrence notification information indicates the degree of abnormality occurring in the cycle. In other words, in this example, the position of the abnormality occurrence notification information indicates the abnormality degree information. Therefore, the abnormality degree information is information visually recognized by the user according to the position of the abnormality occurrence notification information displayed in the search result display region R1. Therefore, in this example, the user can determine the degree of abnormality occurring in the cycle based on the position of the abnormality occurrence notification information displayed in the search result display region R1. For example, when occurrence of a failure of the injection molding apparatus, such as a clamping force is suspected as the abnormality occurring in the cycle, a countermeasure for the abnormality occurring in the cycle, such as repair by a manufacturer, may take time. In this way, the user can determine whether the countermeasure takes time according to the item of the cycle-related information displayed in association with the abnormality occurrence notification information. Then, the degree of abnormality occurring in the cycle increases as the abnormality requires more time in the countermeasure. Therefore, the position of the abnormality occurrence notification information displayed in the search result display region R1 indicates the degree of abnormality occurring in the cycle, and is the abnormality degree information itself. In other words, in this example, the search result display region R1 itself is the abnormality degree information.

In the example shown in FIG. 7, the abnormality occurrence notification information A1 and the abnormality occurrence notification information A2 indicate that the monitoring condition for the cycle time is not satisfied in two cycles, that is, the cycle corresponding to the cycle data SD1 and the cycle corresponding to the cycle data SD3. In this way, when the abnormality occurrence notification information is displayed in association with a specific piece of cycle-related information in the plurality of pieces of cycle data, there is a high possibility that the abnormality occurring in the cycle is not an abnormality that accidentally occurs. Further, the larger the number of pieces of abnormality occurrence notification information displayed in association with the specific piece of cycle-related information is, the higher a priority order for removing a cause of the cycle-related information not satisfying the monitoring condition is. This is because the monitoring condition for the cycle-related information is not satisfied repeatedly with a high probability unless the cause is removed. That is, the number of pieces of abnormality occurrence notification information also indicates the degree of abnormality occurring in the cycle. In other words, the abnormality degree information is also information visually recognized by the user based on the number of pieces of abnormality occurrence notification information displayed in the search result display region R1. In this example, it can also be said that the search result display region R1 itself is the abnormality degree information.

Further, unlike the example shown in FIG. 7, when the abnormality occurrence notification information A1 and the abnormality occurrence notification information A2 are displayed in association with the cycle-related information different from each other, by comparing the item of the cycle-related information displayed in association with the abnormality occurrence notification information A1 with the item of the cycle-related information displayed in association with the abnormality occurrence notification information A2, the user can determine which abnormality among the abnormalities occurring in the cycle has an item with a higher degree of priority of the countermeasure. That is, in this case, the abnormality degree information is also information visually recognized by the user according to the position of the abnormality occurrence notification information displayed in the search result display region R1. In other words, the search result display region R1 itself is also the abnormality degree information.

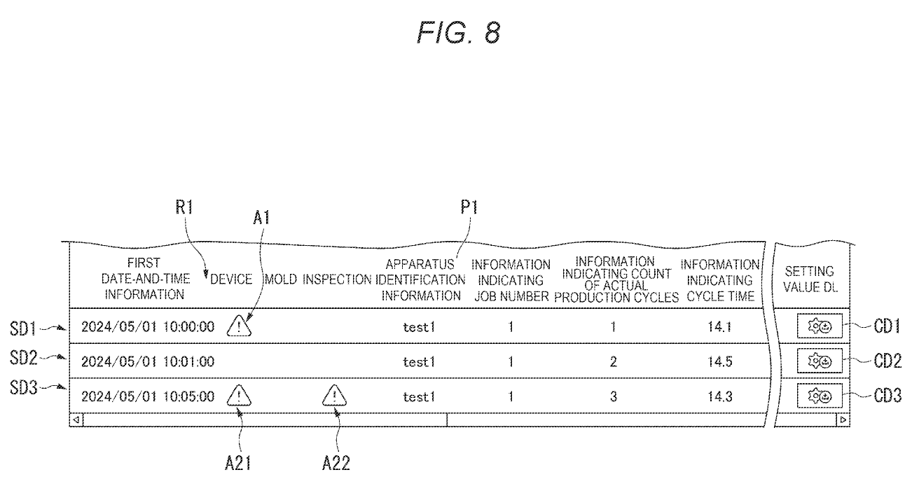

As shown in FIG. 8, the information processing device X may be configured to display the abnormality degree information together with the abnormality occurrence notification information in the search image P1. FIG. 8 is a diagram showing a second example of the state of the search result display region R1 in which the abnormality degree information is displayed together with the abnormality occurrence notification information. In the example shown in FIG. 8, the search result list includes, for each piece of cycle data, a region associated with an occurrence source of the abnormality occurring in the cycle. Examples of the occurrence source of the abnormality occurring in the cycle include the injection molding apparatus, the mold attached to the injection molding apparatus, and the quality of the product. Therefore, in this example, each of the cycle data SD1 to the cycle data SD3 includes three regions, that is, a region associated with the injection molding apparatus, a region associated with the mold attached to the injection molding apparatus, and a region associated with the quality of the product. In FIG. 8, the region associated with the injection molding apparatus is labeled with an "apparatus". In FIG. 8, the region associated with the mold attached to the injection molding apparatus is labeled with a "mold". In FIG. 8, the region associated with the quality of the product is labeled with "inspection". Hereinafter, for convenience of description, the three regions are collectively referred to as an occurrence source region. The occurrence source of the abnormality occurring in the cycle is not limited thereto. Further, in this example, in the search result list, three pieces of abnormality occurrence notification information, that is, abnormality occurrence notification information A1, abnormality occurrence notification information A21, and abnormality occurrence notification information A22 are displayed. Then, the abnormality occurrence notification information A1 is displayed in an occurrence source region associated with the injection molding apparatus in the cycle data SD1. This indicates that the abnormality occurring in the cycle corresponding to the cycle data SD1 is the abnormality occurring in the injection molding apparatus. On the other hand, the abnormality occurrence notification information A21 and the abnormality occurrence notification information A22 are displayed respectively in two occurrence source regions in the cycle data SD3. Specifically, the abnormality occurrence notification information A21 is displayed in an occurrence source region associated with the injection molding apparatus in the cycle data SD3. The abnormality occurrence notification information A22 is displayed in an occurrence source region associated with the quality of the product in the cycle data SD3. This indicates that the abnormality occurring in the cycle corresponding to the cycle data SD3 is an abnormality occurring in both the injection molding apparatus and the quality of the product. In this way, in this example, the position of the abnormality occurrence notification information is discriminated by the region in which the abnormality occurrence notification information is displayed among the three occurrence source regions. In this case, the user can easily specify the occurrence source of the abnormality in each cycle in which the abnormality occurs. As a result, the user can determine to preferentially perform a countermeasure for which abnormality, according to the occurrence source in which the abnormality occurs. That is, in this example, similarly to the abnormality occurrence notification information shown in FIG. 7, the degree of abnormality occurring in the cycle is indicated by the position of the abnormality occurrence notification information. For example, by viewing the search result list shown in FIG. 8, the user can easily specify that no abnormality occurs in the mold and can determine that there is no need to repair the mold urgently. A method of determining whether the abnormality occurring in the cycle is the abnormality occurring in the injection molding apparatus, the abnormality occurring in the mold attached to the injection molding apparatus, or the abnormality occurring in the quality of the product may be a known method or may be a method developed in the future. For example, the information processing device X determines whether the abnormality occurring in the cycle is the abnormality occurring in the injection molding apparatus, the abnormality occurring in the mold attached to the injection molding apparatus, or the abnormality occurring in the quality of the product, according to that which feature value among the feature values indicated by the one or more pieces of feature value information contained in the cycle data does not satisfy the monitoring condition. That is, when a feature value which does not satisfy the monitoring condition among feature values indicated by one or more pieces of feature value information contained in a certain piece of cycle data is a value related to the abnormality of the injection molding apparatus, the information processing device X determines that the abnormality occurring in the cycle is the abnormality occurring in the injection molding apparatus. Further, when a feature value which does not satisfy the monitoring condition among feature values indicated by one or more pieces of feature value information contained in a certain piece of cycle data is a value related to the abnormality of the mold attached to the injection molding apparatus, the information processing device X determines that the abnormality occurring in the cycle is the abnormality occurring in the mold. Further, when a feature value which does not satisfy the monitoring condition among feature values indicated by one or more pieces of feature value information contained in a certain piece of cycle data is a value related to the abnormality of the quality of the product, the information processing device X determines that the abnormality occurring in the cycle is the abnormality occurring in the quality of the product.

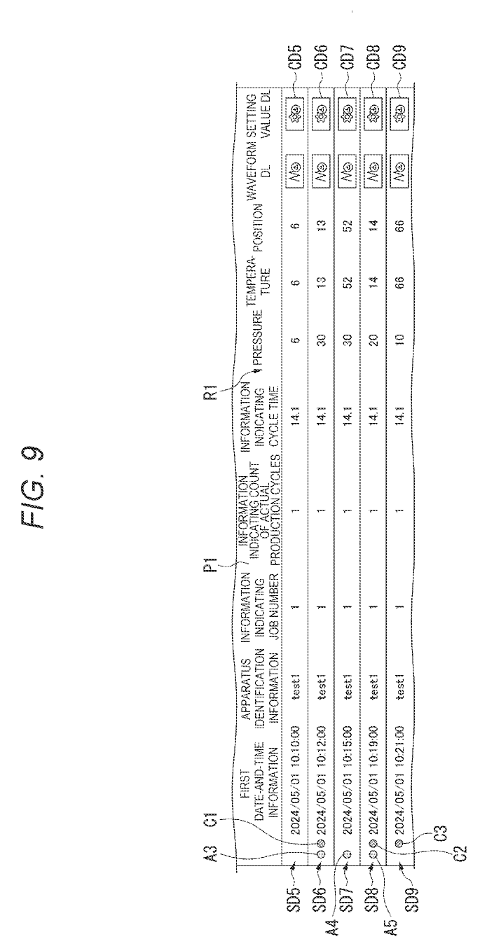

As shown in FIG. 9, the information processing device X may be configured to display the abnormality degree information together with the abnormality occurrence notification information in the search image P1. FIG. 9 is a diagram showing a third example of the state of the search result display region R1 in which the abnormality degree information is displayed together with the abnormality occurrence notification information. In the example shown in FIG. 9, in the search result display region R1, a search result list including five pieces of cycle data, that is, cycle data SD5 to cycle data SD9 is displayed. The association information is displayed in association with each of the five pieces of cycle data. Specifically, association information CD5 is displayed in association with the cycle data SD5. Further, association information CD6 is displayed in association with the cycle data SD6. Further, association information CD7 is displayed in association with the cycle data SD7. Further, association information CD8 is displayed in association with the cycle data SD8. Further association information CD9 is displayed in association with the cycle data SD9.

Here, in the search result display region R1 shown in FIG. 9, the abnormality occurrence notification information is displayed in association with three pieces of cycle data, that is, the cycle data SD6 to the cycle data SD8. Specifically, abnormality occurrence notification information A3 is displayed in association with the cycle data SD6. The display indicates that an abnormality occurs in a cycle corresponding to the cycle data SD6. Further, abnormality occurrence notification information A4 is displayed in association with the cycle data SD7. The display indicates that an abnormality occurs in a cycle corresponding to the cycle data SD7. Further, abnormality occurrence notification information A5 is displayed in association with the cycle data SD8. The display indicates that an abnormality occurs in a cycle corresponding to the cycle data SD8. In the example shown in FIG. 9, each of the abnormality occurrence notification information A3 to the abnormality occurrence notification information A5 is smaller than the shape of the abnormality occurrence notification information shown in each of FIGS. 5, 7, and 8, and has a different shape. Specifically, each of the abnormality occurrence notification information A3 to the abnormality occurrence notification information A5 is indicated by "●". In this example, each of the abnormality occurrence notification information A3 to the abnormality occurrence notification information A5 is displayed at a left end of the associated cycle data. Accordingly, the information processing device X can reduce a size of the search result display region R1, for example.

In the search result display region R1 shown in FIG. 9, injection molding condition change information is displayed in association with each of the cycle data SD6, the cycle data SD8, and the cycle data SD9. The injection molding condition change information displayed in association with a certain piece of cycle data is information indicating that the injection molding condition set in the injection molding apparatus in a cycle corresponding to the cycle data is changed from the injection molding condition set in the injection molding apparatus in a cycle executed before the above cycle. In the example shown in FIG. 9, injection molding condition change information C1 is displayed in association with the cycle data SD6. The display indicates that the injection molding condition set in the injection molding apparatus in the cycle corresponding to the cycle data SD6 is changed from the injection molding condition set in the injection molding apparatus in a cycle corresponding to the cycle data SD5. In this example, injection molding condition change information C2 is displayed in association with the cycle data SD8. The display indicates that the injection molding condition set in the injection molding apparatus in the cycle corresponding to the cycle data SD8 is changed from the injection molding condition set in the injection molding apparatus in the cycle corresponding to the cycle data SD7. In this example, injection molding condition change information C3 is displayed in association with the cycle data SD9. The display indicates that the injection molding condition set in the injection molding apparatus in a cycle corresponding to the cycle data SD9 is changed from the injection molding condition set in the injection molding apparatus in the cycle corresponding to the cycle data SD8.

Here, when the injection molding condition data associated with two pieces of cycle data continuously arranged in time series in the search result display region R1 is different from each other, the information processing device X displays the injection molding condition change information indicating that the injection molding condition is changed in the search result display region R1 in association with the cycle data having a newer one among the date and time indicated by the first date-and-time information contained in the two pieces of cycle data. Here, when there is a difference between one or more pieces of injection molding condition information contained in one of two pieces of injection molding condition data having common apparatus identification information and one or more pieces of injection molding condition information contained in the other of the two pieces of injection molding condition data, the information processing device X specifies that the two pieces of injection molding condition data are different. That is, the information processing device X specifies whether the two pieces of injection molding condition data are different from each other without using information other than the injection molding condition information such as the second date-and-time information. Therefore, even if the injection molding condition data associated with the two pieces of cycle data is data stored in different storage areas of the information processing device X, when there is no difference between the one or more pieces of injection molding condition information contained in each of the two pieces of injection molding condition data, the information processing device X specifies that the two pieces of injection molding condition data are the same.

By such a specifying method, the information processing device X can display the injection molding condition change information in the search result display region R1. Then, as shown in FIG. 9, when the injection molding condition change information is displayed together with the abnormality occurrence notification information, the user can confirm, for example, whether the abnormality that occurs in the cycle is resolved by changing the injection molding condition. In the example shown in FIG. 9, among the cycles corresponding to the respective cycle data contained in the search result list, a cycle in which the abnormality starts to occur is the cycle corresponding to the cycle data SD6. Then, the injection molding condition change information is displayed in association with the cycle data SD6. In this case, for example, the user can determine that an abnormality occurs in the cycle corresponding to the cycle data SD6 due to the change in the injection molding condition set in the injection molding apparatus in the cycle corresponding to the cycle data SD5. Further, it is considered that the abnormality thus determined to occur continues to occur until the cycle corresponding to the cycle data SD9 is executed. This is because the abnormality occurrence notification information is displayed in association with each of the cycle data SD6 to the cycle data SD8 in the search result display region R1 shown in FIG. 9. Then, the abnormality occurrence notification information is not displayed in association with the cycle data SD9, and the injection molding condition change information is displayed in association. This is highly likely to indicate that the abnormality continuously occurring in the cycle is resolved by changing the injection molding condition set in the injection molding apparatus in the cycle corresponding to the cycle data SD8. In this case, the user can determine that the abnormality that occurs in the cycle is already resolved, and that there is no need to perform a countermeasure for the abnormality. Therefore, by displaying the injection molding condition change information in the search result display region R1 together with the abnormality occurrence notification information, the information processing device X can determine whether an urgency in a countermeasure for the abnormality occurring in the cycle is high. That is, in the example shown in FIG. 9, the abnormality degree information is indicated by a combination of the abnormality occurrence notification information and the injection molding condition change information. In FIG. 9, the injection molding condition change information is indicated by the same "●" as the abnormality occurrence notification information. However, the "●" indicating the abnormality occurrence notification information and "●" indicating the injection molding condition change information are different in color. In FIG. 9, the color difference is represented by a difference in hatching. The information processing device X may be configured to represent the difference between the abnormality occurrence notification information and the injection molding condition change information by another display pattern, such as a shape instead of the color. Further, the information processing device X may be configured to display, in the search result display region R1, countermeasure completion information indicating that the countermeasure for the abnormality occurring in the cycle is performed, in association with the cycle data corresponding to the cycle to be executed after the countermeasure is performed. In this case, the information processing device X or the injection molding apparatus receives information indicating that the countermeasure for the abnormality occurring in the cycle is performed as the countermeasure completion information. The method of the information processing device X receiving the countermeasure completion information may be a known method or a method to be developed in the future. Each piece of injection molding condition change information shown in FIG. 9 can also be treated as an example of the countermeasure completion information. Therefore, in the present embodiment, a description of the countermeasure completion information with reference to the drawings will be omitted.

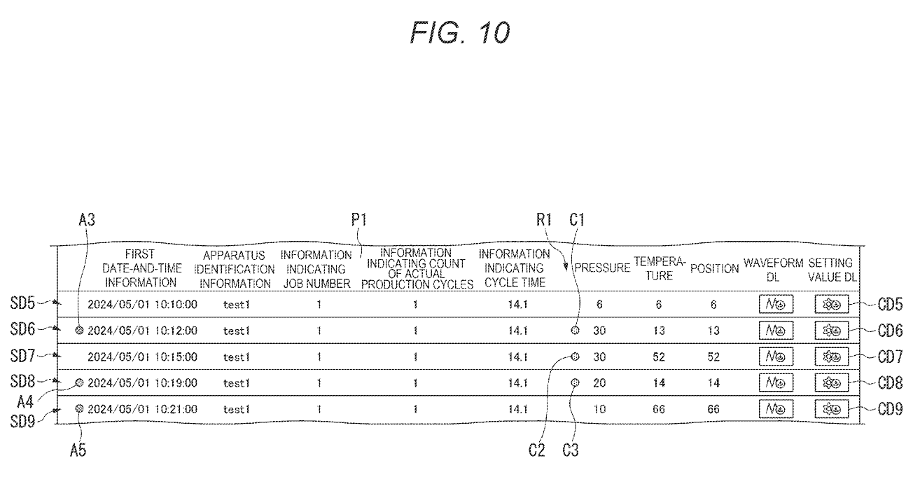

Here, in the example shown in FIG. 9, as described above, the abnormality occurrence notification information is displayed at the left end of the cycle data displayed in association. However, the abnormality occurrence notification information may be displayed at another position corresponding to the cycle data displayed in association. For example, as the abnormality occurrence notification information shown in FIG. 7, the information processing device X may be configured to display the abnormality occurrence notification information in association with the cycle-related information indicating the cycle time among the one or more pieces of cycle-related information contained in the cycle data. FIG. 10 is a diagram showing a fourth example of the state of the search result display region R1 in which the abnormality degree information is displayed together with the abnormality occurrence notification information. In other words, FIG. 10 is a diagram showing a modification of the display pattern of the abnormality occurrence notification information and the abnormality degree information displayed in the search result display region R1 shown in FIG. 9.

In the example shown in FIG. 10, as in the example shown in FIG. 9, the abnormality occurrence notification information A3 to the abnormality occurrence notification information A5 and the injection molding condition change information C1 to the injection molding condition change information C3 are displayed. However, each of the injection molding condition change information C1 to the injection molding condition change information C3 is displayed in association with one piece of cycle-related information, unlike the example shown in FIG. 9. Specifically, the injection molding condition change information C1 is displayed in association with information indicating the pressure among the cycle-related information contained in the cycle data SD6. The display means that the monitoring condition for the pressure is not satisfied. The injection molding condition change information C2 is displayed in association with information indicating the pressure among the cycle-related information contained in the cycle data SD7. The display means that the monitoring condition for the pressure is not satisfied. The injection molding condition change information C3 is displayed in association with information indicating the pressure among the cycle-related information contained in the cycle data SD8. The display means that the monitoring condition for the pressure is not satisfied.

In this way, when the abnormality occurrence notification information is displayed in association with at least one among the one or more pieces of cycle-related information contained in the cycle data, the user can determine whether to preferentially perform the countermeasure, according to an item of the cycle-related information displayed in association with the abnormality occurrence notification information and a timing when the injection molding condition is changed. For example, in this case, the user can specify that the abnormality occurring in the cycle is an abnormality of the pressure in the mold attached to the injection molding apparatus and is resolved by changing the injection molding condition. As a result, the user can determine that the abnormality that occurs in the cycle is not an abnormality that requires an urgent countermeasure. Therefore, in the example shown in FIG. 10, the abnormality degree information is also indicated by a combination of the abnormality occurrence notification information and the injection molding condition change information.

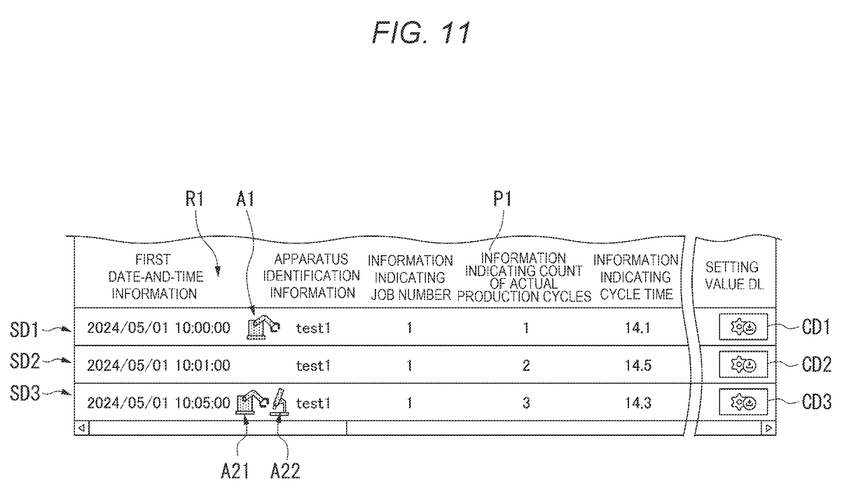

As shown in FIG. 11, the information processing device X may be configured to indicate the occurrence source by the shape of the abnormality occurrence notification information. FIG. 11 is a diagram showing a fifth example of the state of the search result display region R1 in which the abnormality degree information is displayed together with the abnormality occurrence notification information. In the example shown in FIG. 11, in the search result display region R1, three pieces of cycle data, that is, the cycle data SD1 to the cycle data SD3 are displayed, as in the example shown in FIG. 8. However, in this example, the occurrence source region is not displayed in the search result display region R1. Instead, in this example, the abnormality occurrence notification information A1 is a mark having a shape indicating the injection molding apparatus. The mark indicates that the abnormality occurring in the cycle corresponding to the cycle data SD1 is an abnormality occurring in the injection molding apparatus. That is, in this example, the user can easily specify, by viewing the shape of the abnormality occurrence notification information A1, that the abnormality occurring in the cycle corresponding to the cycle data SD1 is an abnormality occurring in the injection molding apparatus. In this example, the abnormality occurrence notification information A21 is a mark having a shape indicating the injection molding apparatus. In this example, the abnormality occurrence notification information A22 is a mark indicating a microscope. These marks indicate that the abnormality occurring in the cycle corresponding to the cycle data SD3 is an abnormality occurring in both the injection molding apparatus and the quality of the product. In this way, in this example, the occurrence source of the abnormality occurring in the cycle is indicated by the shape of the abnormality occurrence notification information. In this case, the user can also easily specify the occurrence source of the abnormality in each cycle in which the abnormality occurs. As a result, the user can determine to preferentially perform a countermeasure for which abnormality, according to the occurrence source in which the abnormality occurs. That is, in this example, the degree of abnormality occurring in the cycle is indicated by the shape of the abnormality occurrence notification information. For example, by viewing the search result list shown in FIG. 11, the user can easily specify that no abnormality occurs in the mold and can determine that there is no need to repair the mold urgently.

Further, the information processing device X may be configured to indicate the degree of the abnormality occurring in the cycle by the color or shape of the abnormality occurrence notification information. Hereinafter, as an example, a case in which the information processing device X indicates the degree of the abnormality occurring in the cycle by the color of the abnormality occurrence notification information will be described. In this case, the information processing device X determines a degree to which the monitoring condition for each feature value is not satisfied, and determines the color of the abnormality occurrence notification information according to the determination result. Hereinafter, for convenience of description, a degree to which the monitoring condition for a certain feature value is not satisfied is referred to as an abnormality level of the feature value. Hereinafter, in order to simplify the description, as an example, a case in which the abnormality level is represented by two levels, that is, level 1 and level 2 will be described. The abnormality level of a certain feature value being level 2 indicates that a degree to which the monitoring condition for the feature value is not satisfied being larger than that when the abnormality level of the feature value is level 1. In this case, the abnormality degree information is the color of the abnormality occurrence notification information. For example, the abnormality level being level 1 means that there is a high possibility that an abnormality occurs in the quality of the product injection-molded by the injection molding apparatus, but the disclosure is not limited thereto. Further, for example, the abnormality level being level 2 means that it is estimated that an abnormality occurs in the quality of the product injection-molded by the injection molding apparatus, but the disclosure is not limited thereto. A method of specifying the abnormality level by the information processing device X will be described later.

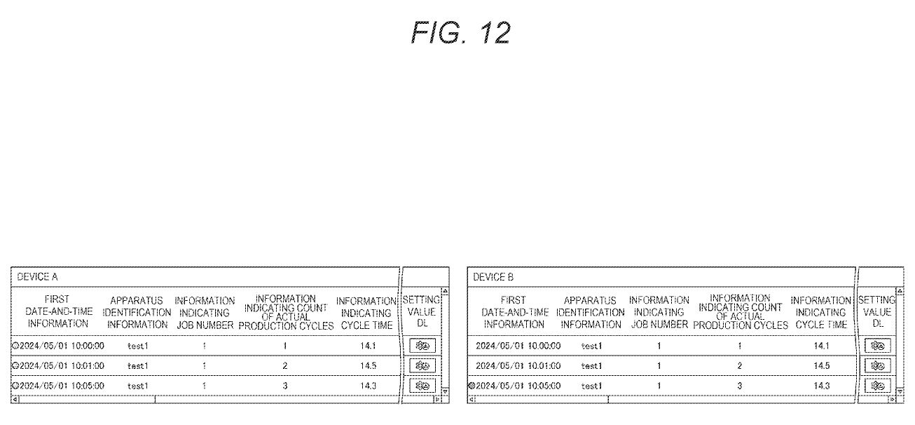

FIG. 12 is a diagram for comparing the abnormality occurrence notification information having different colors. FIG. 12 shows the search result display region R1 in which a list of cycle data including apparatus identification information for identifying "device A" as an example of the injection molding apparatus is displayed as the search result list, and the search result display region R1 in which a list of cycle data including apparatus identification information for identifying "device B" as another example of the injection molding apparatus is displayed as the search result list. Hereinafter, for convenience of description, the list of cycle data including the apparatus identification information for identifying "device A" as an example of the injection molding apparatus is referred to as a search result list of the device A. Meanwhile, hereinafter, for convenience of description, the list of cycle data including the apparatus identification information for identifying "device B" as an example of the injection molding apparatus, is referred to as a search result list of the device B.

In the search result list of the device A, three pieces of cycle data are displayed. Further, the abnormality occurrence notification information is displayed in association with each of the three pieces of cycle data. However, all the abnormality occurrence notification information displayed in the search result list of the device A is abnormality occurrence notification information of a color indicating that the abnormality level is level 1. Meanwhile, in the search result list of the device B, three pieces of cycle data are also displayed. However, in the search result list of the device B, abnormality occurrence notification information of a color indicating that the abnormality level is level 2 is displayed in only one of the three pieces of cycle data. Here, in FIG. 12, a difference in the color of the abnormality occurrence notification information is represented by a difference in hatching of the abnormality occurrence notification information. By comparing the search result list of the device A with the search result list of the device B, the user can easily specify that a degree of the abnormality occurring in the cycle executed by the device B is larger than a degree of the abnormality occurring in the cycle executed by the device A. Further, for example, since the color of the abnormality occurrence notification information indicates level 1 as the abnormality level even though the abnormality repeatedly occurs in the cycle executed by the device A, the user can determine that urgency of a countermeasure for the abnormality occurring in the cycle is not high. This is because, since the color of the abnormality occurrence notification information indicates an abnormality level of level 1, there is a high possibility that the abnormality occurs in the quality of the product injection-molded by the injection molding apparatus, but it can be determined that the abnormality does not actually occur in the quality of the product. On the other hand, for example, since the color of the abnormality occurrence notification information indicates an abnormality level of level 2 even though the abnormality occurs only once in the cycle executed by the device B, the user can determine that urgency of a countermeasure for the abnormality occurring in the cycle is high. This is because, since the abnormality level indicated by the color of the abnormality occurrence notification information is level 2, it can be determined that an abnormality occurs in the quality of the product injection-molded by the injection molding apparatus when the injection molding apparatus continues to execute the cycle without performing a countermeasure for the abnormality occurring in the cycle.

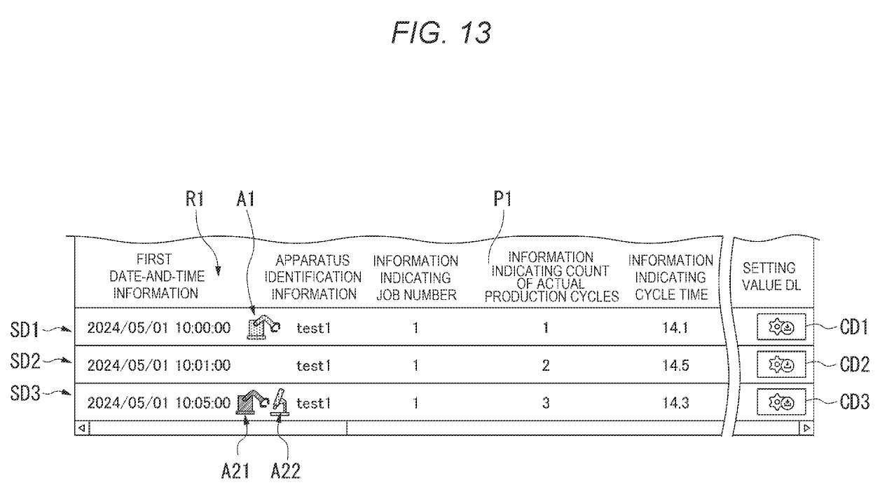

The indication of the abnormality level by the color of the abnormality occurrence notification information may be combined with, for example, the indication of the occurrence source of the abnormality by the shape of the abnormality occurrence notification information as shown in FIG. 11. FIG. 13 is a diagram showing a modification of the search result display region R1 shown in FIG. 11. In FIG. 13, as in FIG. 11, a list of three pieces of cycle data, that is, the cycle data SD1 to the cycle data SD3, is displayed as the search result list, and three pieces of abnormality occurrence notification information, that is, the abnormality occurrence notification information A1, the abnormality occurrence notification information A21, and the abnormality occurrence notification information A22, are displayed. However, in FIG. 13, unlike the example shown in FIG. 11, each of a color of the abnormality occurrence notification information A1 and a color of the abnormality occurrence notification information A22 indicates an abnormality level of level 1. Meanwhile, in FIG. 13, a color of the abnormality occurrence notification information A21 indicates an abnormality level of level 2. In FIG. 13, a difference in the color of the abnormality occurrence notification information is represented by hatching of the abnormality occurrence notification information.

In the example shown in FIG. 13, for example, since abnormality occurring in the injection molding apparatus in the cycle corresponding to the cycle data SD1 has an abnormality level of level 1, the user can determine that the urgency of the countermeasure is not high. However, in this example, the abnormality occurrence notification information A21 indicates that an abnormality also occurs in the injection molding apparatus in the cycle corresponding to the cycle data SD3, and the abnormality level indicated by the color is level 2. In this example, the abnormality occurrence notification information A22 indicates that an abnormality having an abnormality level of level 1 occurs in the quality of the product injection-molded by the injection molding apparatus in the cycle. In this example, for example, by viewing the abnormality occurrence notification information A21 and the abnormality occurrence notification information A22, the user can determine that there is a high possibility that an abnormality occurs in the quality of the product due to an influence of the abnormality occurring in the injection molding apparatus. As a result, in this example, the user can determine that it is necessary to quickly repair the injection molding apparatus. In this way, more detailed information can be provided to the user by combining the indication of the abnormality level by the color of the abnormality occurrence notification information with, for example, the indication of the occurrence source of the abnormality by the shape of the abnormality occurrence notification information as shown in FIG. 11. That is, the information processing device X makes it possible to efficiently perform a countermeasure for the abnormality that occurs in the cycle.

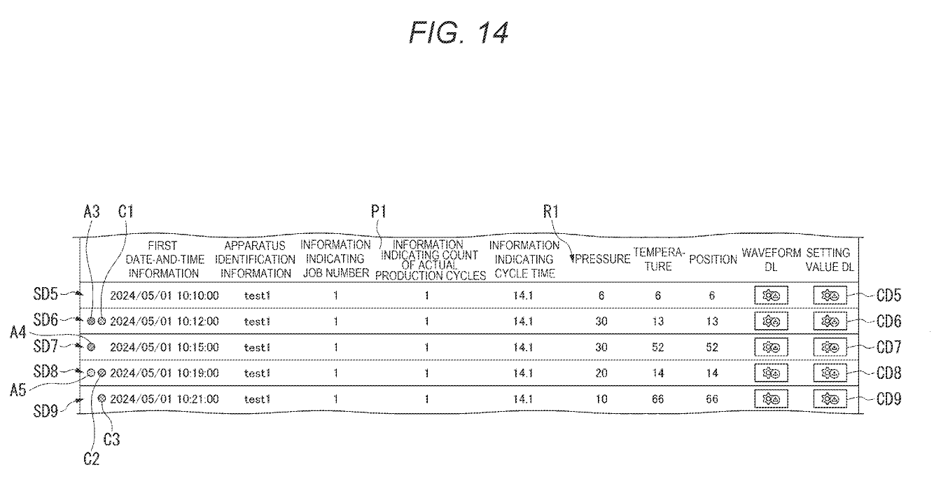

Further, the indication of the abnormality level by the color of the abnormality occurrence notification information may be combined with, for example, the display of the abnormality occurrence notification information and the injection molding condition change information in combination as shown in FIG. 9. FIG. 14 is a diagram showing a modification of the search result display region R1 shown in FIG. 9. In FIG. 14, similarly to FIG. 9, a list of five pieces of cycle data, that is, the cycle data SD5 to the cycle data SD9 is displayed as the search result list, and three pieces of abnormality occurrence notification information, that is, the abnormality occurrence notification information A3 to the abnormality occurrence notification information A5 are displayed. However, in FIG. 14, unlike the example shown in FIG. 9, the color of the abnormality occurrence notification information A5 indicates an abnormality level of level 1. Meanwhile, in FIG. 14, each of the color of the abnormality occurrence notification information A3 and the color of the abnormality occurrence notification information A4 indicates an abnormality level of level 2. In FIG. 14, the difference in the color of the abnormality occurrence notification information is represented by hatching of the abnormality occurrence notification information.

In the example shown in FIG. 14, for example, the user can determine that an abnormality having an abnormality level of level 2 occurs in the cycle corresponding to the cycle data SD6, due to the change of the injection molding condition set in the injection molding apparatus in the cycle corresponding to the cycle data SD5. Further, it is considered that the abnormality thus determined to occur continues to occur until the cycle corresponding to the cycle data SD9 is executed. This is because the abnormality occurrence notification information is displayed in association with each of the cycle data SD6 to the cycle data SD8 in the search result display region R1 shown in FIG. 14. However, while an abnormality level indicated by a color of the abnormality occurrence notification information displayed in association with the cycle data SD7 is level 2, an abnormality level indicated by a color of the abnormality occurrence notification information displayed in association with the cycle data SD8 indicates level 1. This can be considered that, for example, the degree of abnormality occurring in the cycle is reduced by changing the injection molding condition set in the injection molding apparatus in the cycle corresponding to the cycle data SD7. No abnormality occurrence notification information is displayed in association with the cycle data SD9. This can be considered that the abnormality occurring in the cycle is resolved by changing the injection molding condition set in the injection molding apparatus in the cycle corresponding to the cycle data SD8. That is, by viewing the search result display region R1 shown in FIG. 14, the user can determine that the abnormality having an abnormality level of level 2 occurs in the past cycle, but the abnormality is already resolved by changing the injection molding condition set in the injection molding apparatus. Therefore, the information processing device X can more reliably and efficiently perform a countermeasure for the abnormality occurring in the cycle by combining indicating the abnormality level by the color of the abnormality occurrence notification information and displaying the abnormality occurrence notification information and the injection molding condition change information in combination.

As shown in FIG. 14, the combination of indicating the abnormality level by the color of the abnormality occurrence notification information and displaying the abnormality occurrence notification information and the injection molding condition change information in combination can provide the user with various types of information. For example, when the abnormality occurrence notification information having a color indicating an abnormality level of level 2 is displayed together with the injection molding condition change information in the cycle data next to the cycle data in which the abnormality occurrence notification information having a color indicating an abnormality level of level 1 is displayed in association, the user can determine that the degree of the abnormality occurring in the cycle is increased by changing the injection molding condition set in the injection molding apparatus. Further, for example, when the abnormality occurrence notification information having a color indicating an abnormality level of level 1 or level 2 is continuously displayed over a plurality of pieces of cycle data together with the injection molding condition change information, the user can determine that it is not successful to resolve the abnormality by changing the injection molding condition set in the injection molding apparatus.

Here, for each feature value, the information processing device X receives, as the monitoring condition, a plurality of ranges as the limit range for the feature value, thereby specifying the abnormality level. Specifically, first, the information processing device X receives a plurality of ranges as the limit range for each feature value according to the received operation. Hereinafter, as an example, a case in which the information processing device X receives two ranges, that is, a first range and a second range as the limit range for each feature value will be described. The second range is, for example, a range including the first range, but is not limited thereto. When the two ranges are received, if the feature value is out of the first range and the feature value is not out of the second range, the information processing device X specifies that the abnormality level is level 1 as a level indicating a degree to which the feature value does not satisfy the monitoring condition, for example. In this case, when the feature value is out of both the first range and the second range, the information processing device X specifies that the abnormality level is level 2 as the level indicating the degree to which the feature value does not satisfy the monitoring condition, for example. On the other hand, in this case, when the feature value is not out of both the first range and the second range, the information processing device X specifies that the feature value satisfies the monitoring condition, for example. In this way, when the information processing device X receives, as the monitoring condition, a plurality of ranges as the limit range for the feature value, the abnormality level is a level indicating the degree of abnormality occurring in the cycle as described above, and is a level indicating a degree to which at least one of the feature values does not satisfy the monitoring condition.

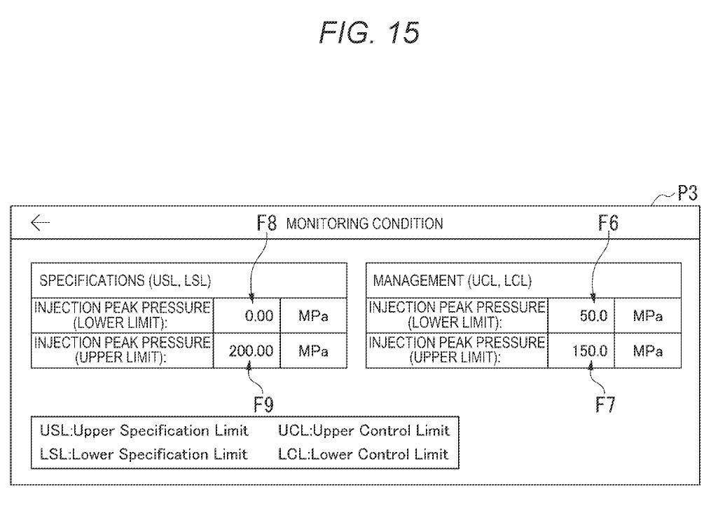

For example, the information processing device X receives two ranges, that is, the first range and the second range via a condition designation image P3 as shown in FIG. 15. FIG. 15 is a diagram showing an example of the condition designation image P3. In FIG. 15, in order to simplify the description, a case in which the number of pieces of feature value information contained in each piece of cycle data is one will be described. Therefore, in the example shown in FIG. 15, the condition designation image P3 is an image for receiving the limit range for one feature value. In FIG. 15, as an example, a case in which the one feature value is the injection peak pressure will be described. In FIG. 15, a case in which the limit range for the injection peak pressure is determined by a two-sided tolerance will be described. In this case, as shown in FIG. 15, the condition designation image P3 includes four input fields, that is, an input field F6, an input field F7, an input field F8, and an input field F9, for example. The condition designation image P3 may include another GUI in addition to the four input fields.

The input field F6 is a field for receiving a lower limit value of the first range for the injection peak pressure. In the example shown in FIG. 12, 50.0 MPa is input to the input field F6 as a value serving as the lower limit value. The lower limit value may be input to the input field F6 by selecting the lower limit value from a pull-down menu, or may be directly input using an input device such as a keyboard.

The input field F7 is a field for receiving an upper limit value of the first range for the injection peak pressure. In the example shown in FIG. 12, 1.50 MPa is input to the input field F7 as a value serving as the upper limit value. The upper limit value may be input to the input field F7 by selecting the upper limit value from a pull-down menu, or may be directly input using an input device such as a keyboard.

The input field F8 is a field for receiving a lower limit value of the second range for the injection peak pressure. In the example shown in FIG. 12, 0.00 MPa is input to the input field F8 as a value serving as the lower limit value. The lower limit value may be input to the input field F8 by selecting the lower limit value from a pull-down menu, or may be directly input using an input device such as a keyboard.

The input field F9 is a field for receiving an upper limit value of the second range for the injection peak pressure. In the example shown in FIG. 12, 2 .00 MPa is input to the input field F9 as a value serving as the upper limit value. The upper limit value may be input to the input field F9 by selecting the upper limit value from a pull-down menu, or may be directly input using an input device such as a keyboard.

When receiving the lower limit value and the upper limit value of the first range for the injection peak pressure via the condition designation image P3, the information processing device X stores a combination of the received lower limit value and upper limit value as the first range for the injection peak pressure. When receiving the lower limit value and the upper limit value of the second range for the injection peak pressure via the condition designation image P3, the information processing device X stores a combination of the received lower limit value and upper limit value as the second range for the injection peak pressure. Thus, the information processing device X stores the monitoring condition for the injection peak pressure. In this way, the information processing device X can receive, via the condition designation image P3, the monitoring condition for the feature value indicated by each of the one or more pieces of feature value information contained in each piece of cycle data. As a result, the information processing device X can indicate in stages that the monitoring condition of each feature value is not satisfied.

The second range for a certain feature value is, for example, a range defined by standards for the feature value. In this case, the feature value being out of the second range means that it is estimated that an abnormality occurs in the quality of the product. On the other hand, the first range for the feature value is, for example, a range determined in a factory or the like for managing the injection molding performed by the injection molding apparatus. In this case, the feature value being out of the first range does not necessarily mean that an abnormality occurs in the quality of the product. The feature value being out of the first range means, for example, that there is a high possibility that an abnormality occurs in the quality of the product. For this reason, it can be said that the abnormality level indicates the degree of abnormality occurring in the cycle as described above. That is, since the color of the abnormality occurrence notification information is a color corresponding to the abnormality level, and can be said to be the abnormality degree information itself.

The information processing device X may be configured to specify the abnormality level using another method. For example, the information processing device X may be configured to specify the abnormality level according to the number of times the monitoring condition of the feature value is not satisfied. In this case, for example, the information processing device X receives, for each feature value, the first range or the second range as the limit range, and receives, as an excess count threshold, a threshold for the number of times the feature value exceeds the monitoring condition. Here, the abnormality occurring in the cycle may suddenly occur only in one cycle, and may occur continuously over a plurality of cycles. Further, the degree of abnormality occurring in the cycle increases as the number of times of continuous occurrence of the abnormality over a plurality of cycles increases. Therefore, for example, the information processing device X specifies that the abnormality level is level 1 when the number of times of occurrence of the abnormality in the cycle does not exceed the excess count threshold, and specifies that the abnormality level is level 2 when the number of times exceeds the excess count threshold.

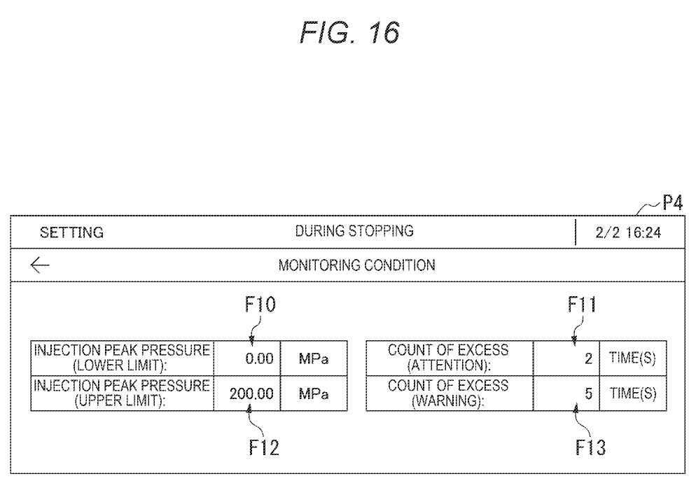

For example, the information processing device X receives the limit range and the excess count threshold via a condition designation image P4 as shown in FIG. 16. FIG. 16 is a diagram showing an example of the condition designation image P4. In FIG. 16, in order to simplify the description, a case in which the number of pieces of feature value information contained in each piece of cycle data is one will be described. Therefore, in the example shown in FIG. 16, the condition designation image P4 is an image for receiving the limit range and the excess count threshold for one feature value. In FIG. 16, as an example, a case in which the one feature value is the injection peak pressure will be described. In FIG. 16, a case in which the limit range for the injection peak pressure is determined by a two-sided tolerance will be described. In this case, as shown in FIG. 16, the condition designation image P4 includes four input fields, that is, an input field F10, an input field F11, an input field F12, and an input field F13, for example. The condition designation image P4 may include another GUI in addition to the four input fields.

The input field F10 is a field for receiving a lower limit value of the limit range for the injection peak pressure. In the example shown in FIG. 16, 0.00 MPa is input to the input field F10 as a value serving as the lower limit value. The lower limit value may be input to the input field F10 by selecting the lower limit value from a pull-down menu, or may be directly input using an input device such as a keyboard.

The input field F11 is an input field for receiving, as an excess count lower threshold, the excess count threshold for the number of times falling below the lower limit value input to the input field F10. In the example shown in FIG. 16, 2 is input to the input field F11 as the excess count lower threshold. The excess count lower threshold may be input to the input field F11 by selecting the excess count lower threshold from a pull-down menu, or may be directly input using an input device such as a keyboard.

The input field F12 is a field for receiving an upper limit value of the limit range for the injection peak pressure. In the example shown in FIG. 16, 200.00 MPa is input to the input field F12 as a value serving as the upper limit value. The upper limit value may be input to the input field F12 by selecting the upper limit value from a pull-down menu, or may be directly input using an input device such as a keyboard.

The input field F13 is an input field for receiving, as an excess count upper threshold, the excess count threshold for the number of times exceeding the upper limit value input to the input field F12. In the example shown in FIG. 16, 5 is input to the input field F13 as the excess count upper threshold. The excess count upper threshold may be input to the input field F13 by selecting the excess count upper threshold from a pull-down menu, or may be directly input using an input device such as a keyboard.

When receiving the lower limit value and the upper limit value of the limit range for the injection peak pressure via the condition designation image P4, the information processing device X stores a combination of the received lower limit value and upper limit value as the monitoring condition for the injection peak pressure. When receiving the excess count lower threshold and the excess count upper threshold via the condition designation image P4, the information processing device X stores the received excess count lower threshold and excess count upper threshold. Accordingly, the information processing device X can store the monitoring condition for the injection peak pressure, and can store the excess count lower threshold and the excess count upper threshold for the injection peak pressure. In this example, the limit range for the injection peak pressure is determined by the two-sided tolerance as described above. Therefore, in the example shown in FIG. 16, the information processing device X receives two excess count thresholds, that is, the excess count lower threshold and the excess count upper threshold. However, the information processing device X may be configured to receive only one of the excess count lower threshold and the excess count upper threshold. Further, the method of the information processing device X specifying the number of times that the monitoring condition for the injection peak pressure is not satisfied may be a known method or may be a method to be developed in the future. For example, when the information processing device X receives only the excess count upper threshold, the information processing device X specifies, for each piece of cycle data contained in the search result list, the number of pieces of cycle data including the feature value information indicating a feature value not satisfying the monitoring condition among the cycle data before a date and time indicated by the first date-and-time information contained in the cycle data, and determines whether the specified number of pieces exceeds the excess count upper threshold. Accordingly, the information processing device X can specify the number of times that the monitoring condition for the injection peak pressure is not satisfied.

The position where the abnormality occurrence notification information is displayed in the search result display region R1 may be another position, instead of all the examples described above.

The abnormality occurrence notification information may be, for example, a highlight such as a row, a column, or a cell of a table displayed in the search result display region R1.

As described above, according to the feature value information of the cycle data contained in the search result list, the information processing device X displays, in the search image P1, the abnormality degree information indicating the degree of the abnormality occurring in the cycle together with the abnormality occurrence notification information for notifying that the abnormality occurs in the cycle. Accordingly, the information processing device X can efficiently perform a countermeasure for the abnormality occurring in the cycle.

The information processing device X may be configured to change the device that displays the abnormality occurrence notification information, according to the degree of the abnormality that occurs in the cycle, or may be configured to notify the abnormality occurrence notification information by a method other than display such as notification of sound, light, a mail, or the social networking service (SNS). Further, the information processing device X may be configured to change a transmission destination according to the degree of the abnormality occurring in the cycle when the abnormality occurrence notification information is notified by notification of a mail, the SNS, or the like. Examples of the transmission destination include, but are not limited to, a worker, a leader of a work process, and a work supervisor. For example, when the abnormality level is level 1, the information processing device X selects the worker as the transmission destination. Meanwhile, when the abnormality level is level 2, the information processing device X selects the leader of the work process, the work supervisor, or the like as the transmission destination.

Return to FIG. 4. The search result display region R1 further includes a button B2 and a check box CH associated with the button B2. Here, in the check box CH, a check mark is displayed when a selection operation is received in a state where no check mark is displayed. On the other hand, in the check box CH, when the selection operation is received in a state where the check mark is displayed, the displayed check mark is deleted.

The button B2 is a button for receiving an operation of outputting one or more pieces of cycle data displayed in the search result display region R1 to another device. However, when a selection operation on the button B2 is received in a state where no check mark is displayed in the check box CH, the information processing device X outputs the one or more pieces of cycle data displayed in the search result display region R1 to the other device. The other device may be, for example, the terminal device 40 or another information processing device communicably connected to the information processing device X. Hereinafter, as an example, a case in which the other device is the terminal device 40 will be described. In the example shown in FIG. 4, the information processing device X outputs the cycle data SD1 to the cycle data SD4 to the terminal device 40 when a selection operation on the button B2 is received in a state where no check mark is displayed in the check box CH. Accordingly, for example, the user can easily acquire the cycle data displayed in the search result display region R1. In other words, for example, the user can easily download the cycle data displayed in the search result display region R1 to the terminal device 40. When the abnormality occurrence notification information is displayed in association with a certain piece of cycle data, and the cycle data is output to another device in this manner, the cycle data may include the abnormality occurrence notification information. However, in this case, the cycle data output to the other device is output as, for example, a CSV file, but is not limited thereto. In this case, the abnormality occurrence notification information is not contained as an image, but as a flag, character information, a value, or the like indicating whether an abnormality occurs in the cycle but is not limited thereto. In this case, whether the cycle data includes the abnormality occurrence notification information may be selectable by the user.

When a selection operation on the button B2 shown in FIG. 4 is received in a state where no check mark is displayed in the check box CH, the information processing device X outputs the four pieces of cycle data to the terminal device 40. On the other hand, when receiving the selection operation on the button B2 in a state where the check mark is displayed in the check box CH, the information processing device X outputs, to the terminal device 40, the one or more pieces of cycle data displayed in the search result display region R1 and the injection molding condition data associated with each of the one or more pieces of cycle data. In the example shown in FIG. 4, in this case, the information processing device X outputs, to the terminal device 40, a combination of the cycle data SD1 and the injection molding condition data associated with the cycle data SD1, a combination of the cycle data SD2 and the injection molding condition data associated with the cycle data SD2, a combination of the cycle data SD3 and the injection molding condition data associated with the cycle data SD3, and a combination of the cycle data SD4 and the injection molding condition data associated with the cycle data SD4. Accordingly, for example, the user can easily acquire the cycle data displayed in the search result display region R1 and the injection molding condition data associated with the cycle data. In other words, for example, the user can easily download the cycle data displayed in the search result display region R1 and the injection molding condition data associated with the cycle data to the terminal device 40. As a result, the information processing device X can make it possible to easily grasp the relation between the cycle of the injection molding in the injection molding apparatus and the injection molding condition set in the injection molding apparatus.

### Hardware Configuration of Information Processing Device X

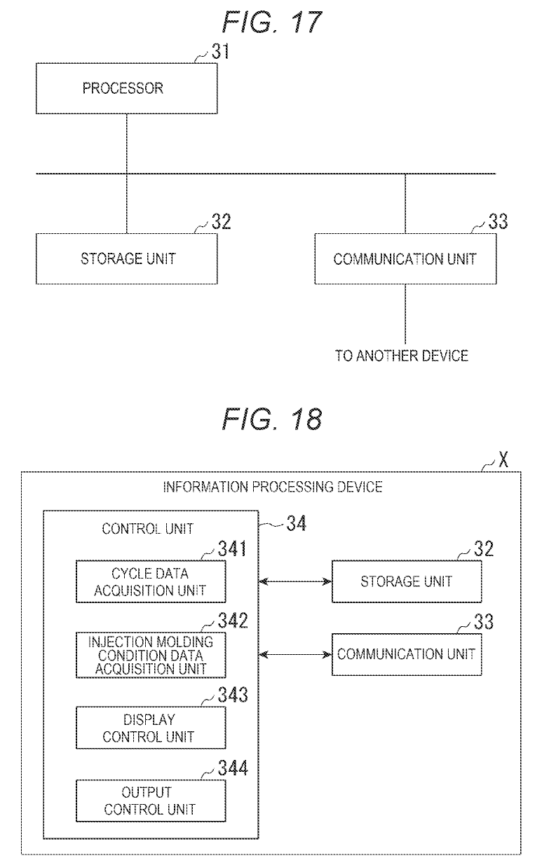

Here, the information processing device 20 and the server 30 may have the same hardware configuration or may have different hardware configurations. Hereinafter, as an example, a case in which the information processing device 20 and the server 30 have the same hardware configuration will be described. In other words, in this example, the information processing device X has a hardware configuration as shown in FIG. 17. FIG. 17 is a diagram showing an example of the hardware configuration of the information processing device X.

The information processing device X includes, for example, a processor 31, a storage unit 32, and a communication unit 33. These component elements are communicably connected to one another via a bus. The information processing device X communicates with other devices via the communication unit 33. For example, when the information processing device X is the information processing device 20, the other devices are the injection molding apparatus, the server 30, the terminal device 40, and the like. For example, when the information processing device X is the server 30, the other devices are the information processing device 20, the terminal device 40, and the like.

The processor 31 is, for example, a central processing unit (CPU). Instead of the CPU, the processor 31 may be another processor such as a field programmable gate array (FPGA). The processor 31 executes various programs stored in the storage unit 32.

The storage unit 32 is, for example, a storage device including a hard disk drive (HDD), a solid-state drive (SSD), an electrically erasable programmable read-only memory (EEPROM), a read-only memory (ROM), and a random access memory (RAM). Instead of being built in the information processing device X, the storage unit 32 may be an external storage device connected to a digital input and output port such as a USB (Universal Serial Bus). The storage unit 32 stores various types of information, various images, and various programs to be processed by the information processing device X. That is, the various types of information stored in the information processing device X are stored in the storage unit 32.

The communication unit 33 is a communication device including, for example, a digital input and output port such as a USB, an Ethernet (registered trademark) port, and an antenna for wireless communication.

### Functional Configuration of Information Processing Device X

Here, the information processing device 20 and the server 30 may have the same functional configuration or may have different functional configurations. Hereinafter, as an example, a case in which the information processing device 20 and the server 30 have the same functional configuration will be described. In other words, in this example, the information processing device X has a functional configuration as shown in FIG. 18. FIG. 18 is a diagram showing an example of the functional configuration of the information processing device X.

The information processing device X includes the storage unit 32, the communication unit 33, and a control unit 34.

The control unit 34 controls the entire information processing device X. The control unit 34 includes at least a cycle data acquisition unit 341, an injection molding condition data acquisition unit 342, a display control unit 343, and an output control unit 344. These functional units provided in the control unit 34 are implemented by, for example, the processor 31 executing the various programs stored in the storage unit 32. A part or all of the functional units may be hardware functional units such as a large scale integration (LSI) or an application specific integrated circuit (ASIC).

The cycle data acquisition unit 341 acquires the cycle data for each cycle of each injection molding apparatus from a device communicably connected to the information processing device X. Examples of the device include the injection molding apparatus and the information processing device 20.

The injection molding condition data acquisition unit 342 acquires injection molding condition data from a device communicably connected to the information processing device X every time the injection molding condition is set in each injection molding apparatus. Examples of the device include the injection molding apparatus and the information processing device 20.

The display control unit 343 generates various images in response to the received operation. For example, the display control unit 343 generates the search image P1. The display control unit 343 transmits the generated images to the terminal device 40 and displays the images on the terminal device 40.

The output control unit 344 outputs various types of data to another device in response to the received operation. For example, the output control unit 344 outputs the download data to another device in response to the operation received via the search image P1.

Process Performed by Information Processing Device X in response to Operation Received via Search Image P1

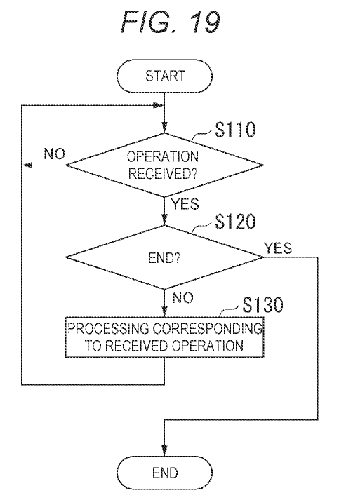

Process performed by the information processing device X in response to the operation received via the search image P1 will be described with reference to FIG. 19. FIG. 19 is a diagram showing an example of a flow of the process performed by the information processing device X in response to the operation received via the search image P1. Hereinafter, as an example, a case in which the search image P1 is displayed on the terminal device 40 at a timing before processing in step S110 shown in FIG. 19 is performed will be described. Hereinafter, as an example, a case in which a plurality of pieces of cycle data and a plurality of pieces of injection molding condition data are already stored in the information processing device X at the timing will be described.

After the search image P1 is displayed, the control unit 34 waits until an operation is received via the search image P1 displayed on the terminal device 40 (step S110). In FIG. 19, the processing in step S110 is indicated by "operation received?".

When it is determined that the operation is received via the search image P1 displayed on the terminal device 40 (step S110-YES), the control unit 34 determines whether the received operation is an operation of ending the processing in the flowchart shown in FIG. 19 (step S120). The control unit 34 may perform the determination processing in step S120 by a known method or by a method to be developed in the future. In FIG. 19, the processing in step S120 is indicated by "end?".

When it is determined that the operation received in step S110 is an operation of ending the processing in the flowchart shown in FIG. 19 (step S120-YES), for example, the control unit 34 deletes the display of the search image P1 from the terminal device 40 and ends the processing in the flowchart shown in FIG. 19.

On the other hand, when it is determined that the operation received in step S110 is not an operation of ending the processing in the flowchart shown in FIG. 19 (step S120-NO), the control unit 34 performs processing corresponding to the received operation (step S130). The processing includes various types of processing described as the processing performed by the information processing device X in the present embodiment. Here, since the processing performed by the control unit 34 in step S130 is already described with reference to FIGS. 2 to 16, a detailed description of the processing will be omitted.

After the processing in step S130 is performed, the control unit 34 transitions to step S110 and waits again until an operation is received via the search image P1 displayed on the terminal device 40.

By the processing as described above, the information processing device X acquires, for each cycle, the cycle data including the one or more pieces of cycle-related information and the first date-and-time information. The information processing device X acquires the injection molding condition data including the one or more pieces of injection molding condition information and the second date-and-time information, every time the injection molding condition is set in the injection molding apparatus. Then, in response to a received operation, the information processing device X displays a combination of a certain piece of cycle data among one or more pieces of the cycle data that are acquired and the association information indicating the injection molding condition data associated with the cycle data among one or more pieces of the injection molding condition data that are acquired. Accordingly, the information processing device X can make it possible to easily grasp the relation between the cycle of injection molding in the injection molding apparatus and the injection molding condition set in the injection molding apparatus.

Further, the information processing device X acquires, for each cycle, the cycle data including the one or more pieces of cycle-related information and the first date-and-time information. The information processing device X acquires the injection molding condition data including the one or more pieces of injection molding condition information and the second date-and-time information, every time the injection molding condition is set in the injection molding apparatus. Then, in response to a received operation, the information processing device X outputs, to another device, a combination of a certain piece of cycle data among one or more pieces of the cycle data that are acquired and the injection molding condition data associated with the cycle data among one or more pieces of the injection molding condition data that are acquired. Accordingly, the information processing device X can also make it possible to easily grasp the relation between the cycle of injection molding in the injection molding apparatus and the injection molding condition set in the injection molding apparatus.

The molding management system 1 described above may include the terminal device 40. The molding management system 1 described above may include an injection molding apparatus such as the injection molding apparatus 11.

In the molding management system 1 described above, the cycle data and the injection molding condition data may be associated with each other by another method. In the molding management system 1 described above, the cycle data and the injection molding condition data may be associated with each other in a one-to-many relationship or a many-to-many relationship.

The contents described above may be combined in any manner.

### Appendix

[1]

A molding management system that manages production of a product in a production process including an injection molding process of the product performed by an injection molding apparatus, the molding management system including: an information processing device communicably connected to a terminal device, in which the information processing device acquires, for each cycle of executing injection molding, cycle data including one or more pieces of cycle-related information obtained in response to execution of the cycle by the injection molding apparatus and first date-and-time information indicating a date and time when the cycle data is acquired from the injection molding apparatus, and displays, in response to a received operation, a data display image displaying a list of one or more pieces of the cycle data, that are acquired, arranged in order of the date and time on a display unit, each of the one or more pieces of cycle-related information includes feature value information indicating a feature value of a quantity detected for each cycle by a detection unit attached to the injection molding apparatus, and according to the feature value information of the cycle data contained in the list, the information processing device displays, in the data display image, abnormality occurrence notification information notifying that an abnormality occurs in the cycle, and indicates, in the data display image, a degree of the abnormality that occurs in the cycle.

[2]

The molding management system according to [1], in which the information processing device acquires injection molding condition data including one or more pieces of injection molding condition information each indicating an injection molding condition set in the injection molding apparatus and second date-and-time information indicating a date and time when the injection molding condition data is acquired from the injection molding apparatus, every time the injection molding condition is set in the injection molding apparatus, and displays association information indicating the injection molding condition data associated with the cycle data contained in the list in association with the corresponding cycle data.

[3]

The molding management system according to [2], in which the injection molding condition data associated with the cycle data is the injection molding condition data acquired at a past date and time closest to the date and time when the cycle data is acquired.

[4]

The molding management system according to [2], in which the cycle data and the injection molding condition data each further include apparatus identification information for identifying the injection molding apparatus.

[5]

The molding management system according to any one of [1] to [4], in which the abnormality that occurs in the cycle includes at least one of an abnormality that occurs in the injection molding apparatus, an abnormality that occurs in a mold attached to the injection molding apparatus, and an abnormality that occurs in a quality of the product injection-molded by the injection molding apparatus.

[6]

The molding management system according to any one of [1] to [5], in which the feature value information is information indicating a time series of the quantity.

[7]

The molding management system according to any one of [1] to [5], in which the feature value information is the feature value.

[8]

The molding management system according to [7], in which the information processing device displays the abnormality occurrence notification information in the data display image and indicates the degree in the data display image in response to whether the feature value indicated by the feature value information of the cycle data contained in the list is out of a first range.

[9]

The molding management system according to [8], in which the abnormality occurrence notification information is a mark displayed in association with the cycle data including the feature value information indicating the feature value out of the first range among the cycle data contained in the list, and the information processing device indicates the degree by at least one of a position of the abnormality occurrence notification information and the number of pieces of the abnormality occurrence notification information.

The molding management system according to [8] or [9], in which in response to the received operation, the information processing device displays, on the display unit, a condition designation image for receiving an operation of designating the first range.

The molding management system according to [9], in which the information processing device indicates the degree by at least the position of the abnormality occurrence notification information in the position of the abnormality occurrence notification information and the number of pieces of the abnormality occurrence notification information, and the position of the abnormality occurrence notification information is discriminated by the cycle data displayed in association with the abnormality occurrence notification information among the cycle data contained in the list.

The molding management system according to , in which the position of the abnormality occurrence notification information is further discriminated by the cycle-related information displayed in association with the abnormality occurrence notification information among the one or more pieces of cycle-related information contained in the cycle data in the list.

The molding management system according to [9], in which the list includes, for each piece of the cycle data, an occurrence source region associated with an occurrence source of the abnormality occurring in the cycle, there are a plurality of the occurrence sources, the occurrence source region is associated with each of the plurality of occurrence sources, and the position of the abnormality occurrence notification information is discriminated by the occurrence source region in which the abnormality occurrence notification information is displayed among the plurality of occurrence source regions.

The molding management system according to [8], in which the information processing device displays the abnormality occurrence notification information in the data display image and indicates the degree, in response to whether the feature value indicated by the feature value information of the cycle data contained in the list is out of the first range and whether the feature value indicated by the feature value information of the cycle data contained in the list is out of a second range different from the first range, the abnormality occurrence notification information is a mark displayed in association with the cycle data including the feature value information indicating the feature value out of the first range or the second range among the cycle data contained in the list, and the information processing device indicates the degree by at least one of a color of the abnormality occurrence notification information and a shape of the abnormality occurrence notification information.

The molding management system according to , in which in response to the received operation, the information processing device displays, on the display unit, a condition designation image for receiving an operation of designating each of the first range and the second range.

The molding management system according to any one of [1] to , in which the information processing device displays the abnormality occurrence notification information in the data display image and indicates the degree in the data display image, according to the number of times that the feature value indicated by the feature value information of the cycle data contained in the list is out of a first range.

The molding management system according to , in which the abnormality occurrence notification information is a mark displayed in association with the cycle data including the feature value information indicating the feature value out of the first range among the cycle data contained in the list, the information processing device indicates the degree by a color of the abnormality occurrence notification information, and the color of the abnormality occurrence notification information is a color indicating that the degree increases as the number of times increases.

The molding management system according to any one of [1] to , in which the information processing device receives countermeasure completion information indicating that a countermeasure for the abnormality occurring in the cycle corresponding to first cycle data designated from among the cycle data contained in the list is performed, and displays the countermeasure completion information in the data display image in association with the first cycle data.

The molding management system described in any one of [1] to , further including the terminal device.

The molding management system according to any one of [1] to , further including the injection molding apparatus.

While the embodiment of the present disclosure has been described in detail with reference to the drawings, the specific configuration thereof is not limited to the embodiment and may be changed, replaced, deleted, or the like without departing from the spirit and scope of the present disclosure.

Further, a program for implementing a function of any component in the device described above may be recorded in a computer-readable recording medium, and the program may be read and executed by a computer system. Here, the device is, for example, the injection molding apparatus 11, the information processing device 20, the server 30, or the terminal device 40. Here, the "computer system" referred to here includes an operating system (OS) and hardware such as peripheral devices. The "computer-readable recording medium" refers to a portable medium such as a flexible disc, a magneto-optical disc, a ROM, or a compact disk (CD) ROM or a storage device such as a hard disk built in the computer system. Further, the "computer-readable recording medium" includes a medium that stores the program for a certain period of time, such as a volatile memory inside the computer system serving as a server or a client when the program is transmitted via a network such as the Internet or a communication line such as a telephone line.

The program may be transmitted from a computer system in which the program is stored in a storage device or the like to another computer system via a transmission medium or by a transmission wave in the transmission medium. Here, the "transmission medium" for transmitting the program refers to a medium having a function of transmitting information like a network such as the Internet or a communication line such as a telephone line.

The program may be a program for implementing a part of the functions described above. Further, the program may be a so-called differential file or differential program that can implement the functions described above in combination with a program already recorded in the computer system.

What is claimed is:

1. A molding management system that manages production of a product in a production process including an injection molding process of the product performed by an injection molding apparatus, the molding management system comprising:
an information processing device communicably connected to a terminal device, wherein
the information processing device
acquires, for each cycle of executing injection molding, cycle data including one or more pieces of cycle-related information obtained in response to execution of the cycle by the injection molding apparatus and first date-and-time information indicating a date and time when the cycle data is acquired from the injection molding apparatus, and
displays, in response to a received operation, a data display image displaying a list of one or more pieces of the cycle data, that are acquired, arranged in order of the date and time on a display unit,
each of the one or more pieces of cycle-related information includes feature value information indicating a feature value of a quantity detected for each cycle by a detection unit attached to the injection molding apparatus, and
according to the feature value information of the cycle data contained in the list, the information processing device displays, in the data display image, abnormality occurrence notification information notifying that an abnormality occurs in the cycle, and indicates, in the data display image, a degree of the abnormality that occurs in the cycle.

2. The molding management system according to claim 1, wherein
the information processing device
acquires injection molding condition data including one or more pieces of injection molding condition information each indicating an injection molding condition set in the injection molding apparatus and second date-and-time information indicating a date and time when the injection molding condition data is acquired from the injection molding apparatus, every time the injection molding condition is set in the injection molding apparatus, and
displays association information indicating the injection molding condition data associated with the cycle data contained in the list in association with the corresponding cycle data.

3. The molding management system according to claim 2, wherein
the injection molding condition data associated with the cycle data is the injection molding condition data acquired at a past date and time closest to the date and time when the cycle data is acquired.

4. The molding management system according to claim 2, wherein
the cycle data and the injection molding condition data each further include apparatus identification information for identifying the injection molding apparatus.

5. The molding management system according to claim 1, wherein
the abnormality that occurs in the cycle includes at least one of an abnormality that occurs in the injection molding apparatus, an abnormality that occurs in a mold attached to the injection molding apparatus, and an abnormality that occurs in a quality of the product injection-molded by the injection molding apparatus.

6. The molding management system according to claim 1, wherein
the feature value information is information indicating a time series of the quantity.

7. The molding management system according to claim 1, wherein
the feature value information is the feature value.

8. The molding management system according to claim 1, wherein
the information processing device displays the abnormality occurrence notification information in the data display image and indicates the degree in the data display image in response to whether the feature value indicated by the feature value information of the cycle data contained in the list is out of a first range.

9. The molding management system according to claim 8, wherein
the abnormality occurrence notification information is a mark displayed in association with the cycle data including the feature value information indicating the feature value out of the first range among the cycle data contained in the list, and
the information processing device indicates the degree by at least one of a position of the abnormality occurrence notification information and the number of pieces of the abnormality occurrence notification information.

10. The molding management system according to claim 8, wherein
in response to the received operation, the information processing device displays, on the display unit, a condition designation image for receiving an operation of designating the first range.

11. The molding management system according to claim 9, wherein
the information processing device indicates the degree by at least the position of the abnormality occurrence notification information in the position of the abnormality occurrence notification information and the number of pieces of the abnormality occurrence notification information, and
the position of the abnormality occurrence notification information is discriminated by the cycle data displayed in association with the abnormality occurrence notification information among the cycle data contained in the list.

12. The molding management system according to claim 11, wherein
the position of the abnormality occurrence notification information is further discriminated by the cycle-related information displayed in association with the abnormality occurrence notification information among the one or more pieces of cycle-related information contained in the cycle data in the list.

13. The molding management system according to claim 9, wherein
the list includes, for each piece of the cycle data, an occurrence source region associated with an occurrence source of the abnormality occurring in the cycle,
there are a plurality of the occurrence sources,
the occurrence source region is associated with each of the plurality of occurrence sources, and
the position of the abnormality occurrence notification information is discriminated by the occurrence source region in which the abnormality occurrence notification information is displayed among the plurality of occurrence source regions.

14. The molding management system according to claim 8, wherein
the information processing device displays the abnormality occurrence notification information in the data display image and indicates the degree, in response to whether the feature value indicated by the feature value information of the cycle data contained in the list is out of the first range and whether the feature value indicated by the feature value information of the cycle data contained in the list is out of a second range different from the first range,
the abnormality occurrence notification information is a mark displayed in association with the cycle data including the feature value information indicating the feature value out of the first range or the second range among the cycle data contained in the list, and
the information processing device indicates the degree by at least one of a color of the abnormality occurrence notification information and a shape of the abnormality occurrence notification information.

15. The molding management system according to claim 14, wherein
in response to the received operation, the information processing device displays, on the display unit, a condition designation image for receiving an operation of designating each of the first range and the second range.

16. The molding management system according to claim 1, wherein
the information processing device displays the abnormality occurrence notification information in the data display image and indicates the degree in the data display image, according to the number of times that the feature value indicated by the feature value information of the cycle data contained in the list is out of a first range.

17. The molding management system according to claim 16, wherein
the abnormality occurrence notification information is a mark displayed in association with the cycle data including the feature value information indicating the feature value out of the first range among the cycle data contained in the list,
the information processing device indicates the degree by a color of the abnormality occurrence notification information, and
the color of the abnormality occurrence notification information is a color indicating that the degree increases as the number of times increases.

18. The molding management system according to claim 1, wherein
the information processing device
receives countermeasure completion information indicating that a countermeasure for the abnormality occurring in the cycle corresponding to first cycle data designated from among the cycle data contained in the list is performed, and
displays the countermeasure completion information in the data display image in association with the first cycle data.

19. The molding management system according to claim 1, further comprising:
the terminal device.

20. The molding management system according to claim 1, further comprising:
the injection molding apparatus.
